(19) United States
(12) Patent Application Publication
(10) Pub. No.: US 2006/0053080 A1
(43) Pub. Date: Mar. 9, 2006

(54) Centralized management of digital rights licensing

(76) Inventors: Brad Edmonson, Franklin, TN (US); Dave Jaworski, Franklin, TN (US); Robin Pou, Dallas, TX (US)

Correspondence Address: FISH & RICHARDSON P.C., P.O. BOX 1022, MINNEAPOLIS, MN, 55440-1022, US

(21) Appl. No.: 11/219,075

(22) Filed: Sep. 1, 2005

Related U.S. Application Data
(63) Continuation-in-part of application No. 10/726,284, filed on Dec. 2, 2003.
(60) Provisional application No. 60/607,045, filed on Sep. 3, 2004.
(60) Provisional application No. 60/444,581, filed on Feb. 3, 2003.

(51) Int. Cl. G06Q 99/00

(52) U.S. Cl. 705/59

(57) ABSTRACT

Systems and techniques managing license rights in digital media involve storing digital media license records associated with multiple user identities. The license records for each user identity are accessible from a remote device using a first authentication credential corresponding to the user identity. Digital media licenses are offered for purchase using second authentication credentials. A particular second authentication credential is associated with the first authentication credential corresponding to a particular user identity. A record for a digital media license purchased using the particular second authentication credential is stored in association with the particular user identity based on the association of the particular second authentication credential with the first authentication credential corresponding to the particular user identity.

### CROSS-REFERENCE TO RELATED APPLICATIONS

This application claims priority from co-pending provisional application Ser. No. 60/607,045, filed Sep. 3, 2004 and is a continuation-in-part of co-pending application Ser. No. 10/726,284, filed Dec. 2, 2003, which claims priority to provisional application Ser. No. 60/444,581, filed on Feb. 3, 2003, all of which are incorporated herein by reference.

### TECHNICAL FIELD

This description relates to digital rights management, and more particularly to facilitating authorized licensing and distribution of digital media.

### BACKGROUND

The music industry is in the midst of significant turmoil. For decades, music companies have been in control of the physical distribution of the content it creates. For the first time in history, consumers have been given tools that have enabled them to seize control of this distribution of content. Rapidly developing and widely adopted technology has resulted in a consumer driven disruptive change to the status quo. The myriad of legal and illegal solutions has proven to be poor attempts to answer and solve the innate challenges of content distribution in a digital world. Although problems with digital distribution of content may be associated to a significant extent with the music industry, other industries, such as the motion picture industry, suffer from the same challenges.

No solution to date has satisfied both the content creator/owner and the consumer. The only digital distribution solution that has been widely adopted is found in the various peer-to-peer networks. However, this solution allows millions of consumers to download music and other forms of copyrighted content without paying for the content they download. Content owners are left with no ability to collect fees owed to them. This situation has caused devastating revenue losses.

Through their endorsement of digital subscription services among other things, many content creating entities such as the music companies have acknowledged that digital distribution is the future. It is the most efficient and economical means of distribution. To date, the music industry has still not fully embraced the potential of this distribution vehicle. Digital distribution is also becoming prevalent in other industries and with respect to many types of content. Problems similar to those faced by the music industry have arisen, or are likely to arise, in the context of other types of content.

Current digital distribution models in the music industry, for example, confine the consumer into artificial purchasing patterns, tend to restrain competition, have only limited song selections, and are limited in terms of other available options. Moreover, these models generally limit how the consumer uses the content they pay for, and some of the models may fail to protect against infringement of rights in the underlying works.

### SUMMARY

In one general aspect, license rights in digital media are managed by storing digital media license records associated with multiple user identities. The license records for each user identity are accessible from a remote device using a first authentication credential corresponding to the user identity. Digital media licenses are offered for purchase using second authentication credentials. A particular second authentication credential is associated with the first authentication credential corresponding to a particular user identity. A record for a digital media license purchased using the particular second authentication credential is stored, in association with the particular user identity, based on the association of the particular second authentication credential with the first authentication credential corresponding to the particular user identity.

Implementations can include one or more of the following features. The first authentication credential and the second authentication credential for each user identity each include a user name and a challenge response. The digital media license records include parameters for a license and/or a digital media file identifier. Multiple device identifiers associated with the particular user identity are stored, and licenses for digital media identified by the license records for the particular user identity allow use of the digital media on devices having one of the device identifiers. The license records include data identifying digital media discovered on a device associated with a user identity. The first authentication credential is associated with a central server and the second authentication credential is associated with a retailer server. The central server stores rules defining an allocation of revenue among multiple entities for purchases of digital media. Credit is allocated to an account associated with a first user identity in response to a purchase of a digital media license using a second user identity if the purchase is made in response to a referral from the first user identity to the second user identity.

In another general aspect, digital media license records associated with multiple user identities are stored. Data identifying a first purchase of a first digital media license from a first retailer entity is received. The data includes information sufficient to identify a particular user identity associated with the first purchase. A record of the first purchase in association with the particular user identity is stored in the digital media license records. Data identifying a second purchase of a second digital media license from a second retailer entity is received. The data includes information sufficient to identify the particular user identity as being associated with the second purchase. A record of the second purchase is stored in the digital media license records in association with the particular user identity.

Implementations can include one or more of the following features. The first purchase and the second purchase are each made using the particular user identity. The record of the first purchase includes an association of a digital media license for the first digital media with the particular user identity, and the record of the second purchase includes an association of a digital media license for the second digital media with the particular user identity. The first purchase and the second purchase are made in response to a referral made using the particular user identity. The record of the first purchase and the record of the second purchase include credits to an account associated with the particular user identity. The credits are usable for making purchases of a digital media license through the first retailer entity and/or the second retailer entity. Access to the records is provided to each of the first retailer entity and the second retailer entity. Revenue from purchases is allocated among the first retailer entity, an owner of the digital media, and an entity associated with the central server. The first retailer entity and the second retailer entity each have independent catalogs of digital media for purchase.

In yet another general aspect, one or more retailer servers are operable to offer digital media licenses for purchase using a retailer-specific authentication credential associated with a particular user identity. A central server stores digital media license records associated with multiple user identities. The license records for the particular user identity are accessible from a remote device using a primary authentication credential associated with the particular user identity. The license records for the particular user identity are automatically updated to include a record of a digital media license purchased using the retailer-specific authentication credential associated with the particular user identity.

Implementations can include one or more of the following features. The central server stores rules defining a distribution of revenue among at least an operator of each retailer server and an operator of the central server. Each retailer server is operable to retrieve information from the digital media license records associated with the particular user identity. The central server stores data identifying credits earned by the particular user identity for purchases made using other user identities, and the purchases are associated with a referral made using the particular user identity. Each retailer server is operable to support a transmission of a licensed digital media file using the particular user identity.

In another general aspect, each of multiple retailer servers is operable to offer digital media licenses for purchase and each retailer server includes an independent digital media catalog. A central server is operable to store digital media license records associated with multiple user identities, and the license records for a particular user identity include a record of a digital media license purchased through a first one of the retailer servers and a digital media license purchased through a second one of the retailer servers.

Implementations can include one or more of the following features. The central server supports a security mechanism for restricting use of a digital media file without a digital media license. The central server provides access to the digital media license records from the retailer servers. The central server stores rules for allocating revenue at least among an operator of the central server and an operator of a retailer server through which a purchase that produces the revenue is made. The central server stores data defining revenues allocated to each of the operator of the central server and the operators of the retailer servers.

### DESCRIPTION OF DRAWINGS

FIG. 1 is a block diagram of a representative system for managing and distributing digital rights.

FIG. 2A is a signaling and flow diagram of a process for purchasing and storing media file licenses.

FIG. 2B is a signaling and flow diagram of a process for purchasing and storing media file licenses from a different retailer server.

FIG. 2C is a signaling and flow diagram of a process for earning and storing referral credits.

FIG. 3 is an example of a user interface that can be used to purchase media file licenses.

FIG. 4 is a flow diagram of a process for managing digital rights to a file that is loaded onto a user device, such as a computer.

FIG. 5 is a flow diagram of a process for installing, on a user device, software (“Solution Software”) that controls access to protected files.

FIG. 6 is a flow diagram of a process for wrapping content that arrives without any digital wrapper on a user device that includes the Solution Software.

FIG. 7 is a signaling and flow diagram of a process for generating a unique customer identifier for a user and/or a key that is specific to the user device.

FIG. 8 is a signaling and flow diagram of a process for accessing a media file in a case where a user already has a license for the media file.

FIG. 9 is a signaling and flow diagram of a process for accessing a media file in a case where a user does not have a license for the media file.

FIG. 10 is a signaling and flow diagram of a process for copying or moving a media file from a user device to a secondary device.

FIG. 11 shows a flow diagram of an illustrative process for performing a pass-along distribution.

FIG. 12 is a flow diagram of a process for wrapping a media file.

Like reference symbols in the various drawings indicate like elements.

### DETAILED DESCRIPTION

The systems and techniques described here relate to a computer-implemented system for distribution and rights management of digital media files. The systems and techniques represent an end-to-end process that supports virtually any type of proprietary digital files including music and other recordings, movies and other video, books and other written works, and other files, such as those that pertain to the financial, legal, medical, gaming, and software industries. Although the following description focuses primarily on the use of the techniques in connection with music files, the techniques are equally applicable to other types of digital files. Similarly, although the techniques are described in the context of media files, the techniques may also be used in connection with multimedia files and other types of data files. The systems and techniques ensure that content owners are compensated for the distribution and use of their works and offer multiple levels of participation in the revenues generated by the sale and/or licensing of digital media.

Digital media licenses, along with an electronic copy of the digital media, are distributed by a network of retailers using a license and distribution management infrastructure provided by a central licensing server. Each of the retailers has its own independent library or catalog of digital media from which users can select digital media licenses for purchase. Data records relating to the digital media licenses are stored in a central database associated with the central licensing server. These data records, for example, identify which digital media files each user is licensed to access and use. Users can purchase licenses to media files from one or more of the retailers and have a centrally managed database identifying all of the licensed media files.

Typically, each retailer has an independent authentication procedure that uses retailer-specific user name and password for each user. In addition, each user has a separate user name and password for accessing the user's data records maintained by the central licensing server. By associating each of the retailer-specific user names with the user name for the central licensing server, digital media licenses that are purchased through the retailers can be recorded in the central license database. In some implementations, such an association may be required, for example, to implement a security mechanism that allows users to access or use the digital media files for which they have purchased licenses. Each retailer can be provided with proxy access to the digital media license database, for example, to enable the retailer to display the user's own library of media file licenses to the user.

Digital media is generally distributed to users' computers or other devices in a “wrapped” form. Media rights owners have the ability to wrap a file with information about ownership and payment. This information is given a unique file ID and is stored in a central database. The file ID is stored and transmitted with the wrapper. Songs or other forms of digital media without the wrapper may also be identified. Once a file is captured and identified, the information such as owner and payment requirements can be retrieved (e.g., by matching the identified file with its unique file ID stored at the central database). Software on the computer or other device is used to control access to wrapped files by determining whether the user has a license for the digital media contained in the wrapped file.

A user ID is created for each user. The user ID can be the same as the user's user name or can be an identifier that is independently created. The user IDs are stored along with device specific information in a secure area on the computer, such as the BIOS of the computer. The user ID may be stored in an encrypted or unencrypted format. This information may represent a user identification key, which may allow access to a local database of licenses and related permissions held by the user. By referring to this local license database, the software stored on the computer can determine whether the user is authorized to use a particular file and, if so, unwrap the file. Because users often have multiple devices and to protect against an accidental loss of license data, information about user licenses are centrally stored to ensure the user has access to all licensed media on more one device and to provide redundant license storage.

A user may be an individual or a set of related individuals, such as a family, members of a household, persons who access a shared private device, or a business entity. In addition, where information is described as being stored in a database, the information may be stored in multiple databases.

Files can be forwarded to other users and otherwise exchanged among users. However, if a file requires a license and the new users do not purchase the media file, the new users do not gain access to the file. To encourage distribution of the file, users are given an incentive to refer or electronically send media files or links to media files to others they feel would be interested in the media files (i.e., to potentially receive a portion of revenues generated by new purchasers). Recipients are given an incentive to purchase the media file (i.e., to be able to access the file) and also to further refer the media file so that they too can participate in revenues. The number of levels of distribution in which participation in revenues is permitted can be unlimited. Typically, however, the number of levels of distribution in which participation in revenues is permitted will be limited. The number of levels of payment for a particular media file may be optionally established by the content owner and/or by a subsequent distributor of the media file. The maximum number of levels of payment and the rates for such payments may be established in the creation of the unique file ID for the media file along with the rates for payment. If the new user does not license the media file, he/she does not gain access to the file, although he/she may be able to pass along the file to other users for purchase.

Information regarding credits earned by each user through referrals to other users is stored in the central license database. These credits can be applied against purchases from any of the various retailers. In addition, the central licensing server maintains rules regarding a distribution of revenue generated through the sale of digital media licenses. Typically, the revenue is divided among an owner of the digital media (e.g., a record label that owns the rights to a song), the retailer that made the sale, an operator of the central licensing server, and, in some cases, one or more referring users.

Each time a sales transaction occurs for a particular media file, identification information for retailers and/or users in the distribution channel is extracted from the media file to determine who is entitled to share in the revenue. All transactions may be centrally tracked for payment and analysis. The central licensing server can be used to track payments for retailers, distributors (which may include users who refer a media file), and users who pass along a file that arrives without a wrapper. This latter situation can occur, for example, when a user shares a song that originated from a standard audio CD or DVD.

Licenses for files may be recognized across multiple devices of a user. The methods and techniques described herein provide processes for selling, distributing, and managing licenses to use digital media.

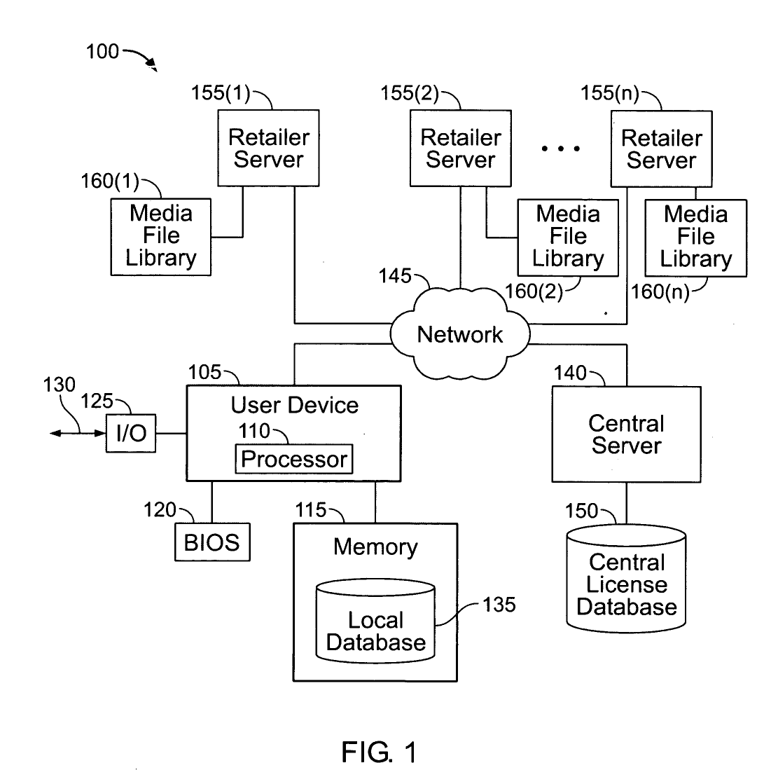

FIG. 1 is a block diagram of a representative system 100 for managing and distributing digital rights. A user device 105 includes a processor 110, which executes instructions stored in a memory 115 and/or other storage media (not shown) that are connected to the user device 105. The user device includes a BIOS (basic input/output system) 120 or some other non-volatile memory that stores basic information about the user device 105. The user device 105 includes one or more I/O ports 125 that permit files and other data to be moved and/or copied onto and off of the user device 105 (as indicated at 130). The processor 110, in accordance with instructions stored in the memory 115, monitors files and other data that pass through the I/O port 125 for purposes of identifying protected (e.g., copyrighted) music, video, software, or other files.

The memory 115 includes a local database 135 that stores license information for files that are licensed to be used on the user device 105. Access to the local database 135, or to the information contained in the local database 135, generally requires certain installed software to decrypt and use one or more keys stored in the BIOS 120. Such keys are unique to the user and/or the user device 105, and the process for accessing the local database 135 is designed such that the keys and/or the license information stored in the local database 135 are only valid for the particular user device 105. For example, if a user attempts to make an unauthorized copy of the key(s) and/or the license information on an alternative device, access to the files that are licensed on the user device may be denied on the alternative device unless a new unique key is generated for, and license information is stored on, the alternative device. License information on a particular device may be updated at a future date, updating usage rights or removing access to a file or files. One example where the capability to perform such an update is desired is de-licensing an old computer.

The user device 105 communicates with a central server 140 through a network 145, which may include one or more of a wireless network, a LAN, a WAN, the Internet, a telephone network, and any other network for transferring data. Communications between the user device 105 and the central server 140 can be performed using a secure channel, such as the Secure Sockets Layer (SSL), and/or can use encryption, such as PGP. The central server 140 provides services that support the digital rights management system 100, such as generating keys using, at least in part, information communicated from the user device 105 over the secure connection and validating keys and license information periodically or when attempting to license new media. In addition, the central server 140 provides access to a central license database 150 that stores and identifies licenses held by individual users and that stores key validation information. Storage of license information in the central license database 150 provides redundancy (e.g., in case there is a corruption of a volatile memory area of a user's device), allows a re-creation of a licensed data environment on another device, allows for transfers of licenses between a user's devices, allows for remote access of license information by the user using a device without a volatile memory area (e.g., some types of cell phones), and allows streaming of licensed digital files.

The central license database 150 can also store information identifying media files that are discovered on the user device 105 by software installed on the device 105 (e.g., files that are present in the device memory before software that discovers the files is installed on the device 105). In some implementations, such files can be assumed to be licensed, at least for the device 105 on which they are present. Limitations may be placed on their use, however, such as by requiring a purchase of a license before allowing the file to be transferred or copied to other devices.

For some types of user devices 105, such as some cellular phones, some of the functions can be performed by components that are remote from the user device. Some cellular phones, for example, may not have the memory capability to store files and license information locally or, depending on the application, it may be otherwise undesirable to do so. In such a case, digital files (such as but not limited to music or video) may be streamed to the user device over a wireless connection. The local database 135 can be located in the wireless network and the processing that determines whether the user device has a license to access particular files can also be performed on a server in the wireless network.

The user device 105 also is capable of communicating with one or more retailer servers 155(1)-155(n) that each offer the ability to download media files from a corresponding media file library 160(1)-160(n) for the retailer server 155 and the ability to purchase licenses to use the media files. The media file library 160 for each retailer server 155 is independent of media file libraries 160 for other retailer servers 155. Thus, each media file library 160 can have a different collection of media files, although in some cases there can be a significant, if not a complete, overlap of media files contained in different media file libraries 160. This situation can occur, for example, where two different retailers are authorized by a particular record label to sell the same song files.

Each retailer server 155 can be implemented as a web server that is accessible using an Internet address. A user can therefore access the retailer server 155 through the user device 105 by directing a browser application on the user device 105 to the Internet address associated with the retailer server 155. The user device 105 can thereafter communicate with the retailer server 155 to request and obtain web pages that list media files available for purchase; display licensing terms, conditions, and pricing; offer search capabilities; enable user logins; and the like.

To purchase a license to use a digital media file and to download the file, each retailer server 155 generally requires the user to login through a conventional authentication process. The authentication process, for example, may use a user name and password, some other challenge response, and/or other authentication credentials to authenticate the user. In addition, at least initially, the user may be required to further login to the central server 140 using a separate authentication process used by the central server 140. By logging onto the central server 140 while logged onto the retailer server 155, the retailer-specific authentication credentials can be associated with the authentication credentials for the central server 140, thereby enabling licenses purchased using through the retailer server 155 (i.e., using the retailer-specific authentication credentials) to be identified and stored in connection with the user's identity (i.e., the user's central server authentication credentials) in the central license database 150 associated with the central server 140. This association of retailer-specific authentication credentials with central server authentication credentials can be performed for multiple different retailer servers 155, such that the user's purchases from different retailer servers 155 are all identified and stored in the central license database 150. A record of purchased licenses can also be stored in the local database 135.

The central server authentication credentials can be different than the keys stored in the BIOS 135. In particular, the keys can be used by software installed on the user device 105 for purposes of ensuring that media files are licensed before allowing access, while the authentication credentials can be used for purposes of allowing a user to access and display lists of licensed media files, license terms, referral credits, and other information stored in the central license database 150.

In general, the central server 140 is responsible for license management and protection against unauthorized access and use of digital media files, and the retailer servers 155 are responsible for allowing users to purchase media file licenses and to download media files. In some cases, however, the central server 140 can also provide retail services. For example, the central server 140 may not provide the ability to download media files but may allow users to purchase licenses to access and use digital media files obtained through other channels (e.g., an unlicensed file obtained through a peer-to-peer network and/or through I/O port 125). Similarly, the retailer servers 155 can provide some license management functions. For example, the retailer servers 155 can access and/or retrieve a particular user's license data from the central license database 150 and can allow the user to view and/or manipulate the license data. Typically, however, any changes relating to licensed media that are made through a retailer server 155 are replicated to the central license database 150, which is responsible for maintaining the primary license record data. Changes to the user account associated with a retailer server 155 or to the user account associated with the central server 140 are maintained locally by the respective servers and are not replicated or otherwise accessible by other servers. Accordingly, account management functions can be provided to users by logging onto the central server 140 or the retailer servers 155 using the respective authentication credentials.

In addition to storing license record data, such as a file ID and license scope parameters (e.g., number of copies/devices allowed, license expirations, and the like), the central server 140 and/or the central license database 150 can store information relating to referrals made by each user. For example, a user can recommend a particular media file that the user has purchased from a retailer server 155 (or that the user has simply located on a web page supported by a retailer server 155) to a friend or other user. The recommendation can be sent by email, instant messaging, or some other format and can include information identifying the referring user. For example, when a user is authenticated with a particular retailer server 155(1), a web page supported by the retailer server 155(1) can include a user interface component (e.g., a button, checkbox, or data entry field) that allows the user to refer a selected media file or files to another user (in addition to a user interface component that allows the user to purchase the media file). As a result, the other user may receive an email with a link to a web page supported by the particular retailer server 155(1) that enables the other user to purchase the media file. By referring a media file in this manner, the referring user can be allocated a credit that can be used in future media file license purchases. The credit is generally stored in the central license database 150, is associated with an identifier for the referring user, and can be used for purchases from any retailer server 155. In some cases, however, the credit may be stored by the retailer server 155 and/or may be used only in connection with purchases from the retailer server 155(1) from which the purchase that resulted in the credit was made.

Credits earned by a particular user for referrals can be retrieved by the retailer servers 155 from the central server 140 once the particular user is authenticated by the retailer server 155, assuming the particular user has previously associated the user's retailer authentication credentials with the user's central server authentication credentials. Tracking of whether a purchase is made as a result of a referral can be performed by the retailer server 155 or by the central server 140 using data contained in a referral link, by routing the referred user through a particular Internet address, or by correlating referral information stored in the retailer server 155 and/or the central server 140 with subsequent purchases.

Information identifying which media files have been referred by each user may also be stored at the central server 140. Users can access and view this information by logging onto the central server 140 with their central server authentication credentials. The retailer servers 155 can access this information or can separately store this information, at least with respect to media files that originated from the respective retailer server 155.

To make purchases from the retailer servers 155, media files offered by the retailer server 155 can be selected by users and added to an online shopping cart. The user can add and remove items, purchase licenses for the selected media files, and save the contents of the shopping cart. In addition, once the user purchases one or more media file licenses, the user can download the licensed media files concurrently with the purchase or at a later time (e.g., when the user has access to a faster connection or would like to download to a different device).

The central server 140 also stores in the central license database 150 information identifying which devices a user has registered for situations in which the user copies media files to different devices. This information allows the central server 140 to determine whether the user has reached a maximum number of devices onto which a media file can be copied, as defined by license rules for each particular media file. In addition, this information can be used to limit downloads of media files to devices that are registered or otherwise associated with a particular user. Information about which devices are associated with each user can be retrieved by the retailer servers 155 from the central server 140.

The central server 140 further supports a set of rules regarding allocation or distribution of proceeds from sales of media file licenses. In the case of music files, the rules typically define a percentage or dollar amount that is to be allocated to the recording company, an operator of the central server 140, and one or more referring users. For example, for a ninety nine cent ($0.99) sale, the recording company might be allocated fifty cents ($0.50), the central server 140 operator might be allocated seven cents ($0.07), a first referring user might be allocated ten cents ($0.10), and a second referring user (i.e., a user that is referred a file by the first referring user and, in turn, refers the file to a third user) might be allocated three cents ($0.30). An operator of the retailer server 155 that made the sale might also be allocated a fixed amount (e.g., $0.29) or might be allocated a remaining amount (i.e., allowing the retailer to set a price that produces a desired profit margin). Alternatively, another entity can be allocated a remaining amount. For example, the operator of the central server 140 can be allocated a remaining amount if the retailer has a fixed allocation or if there are no referrals that require an allocation.

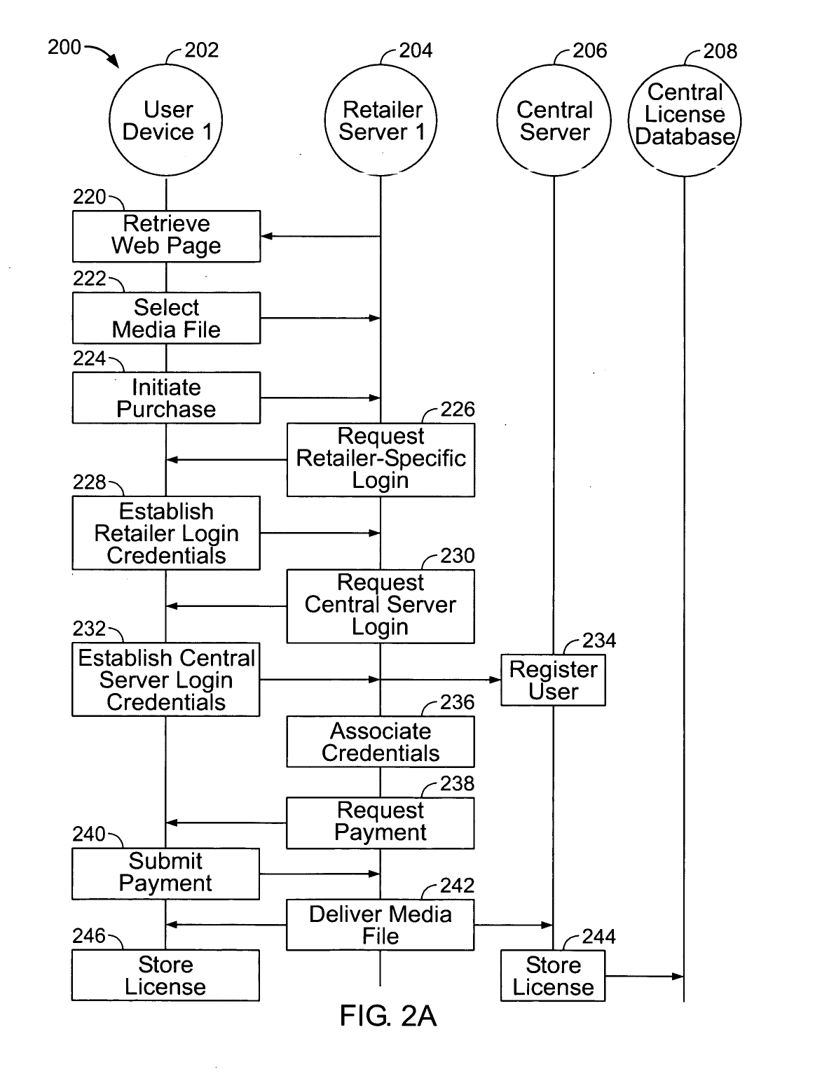

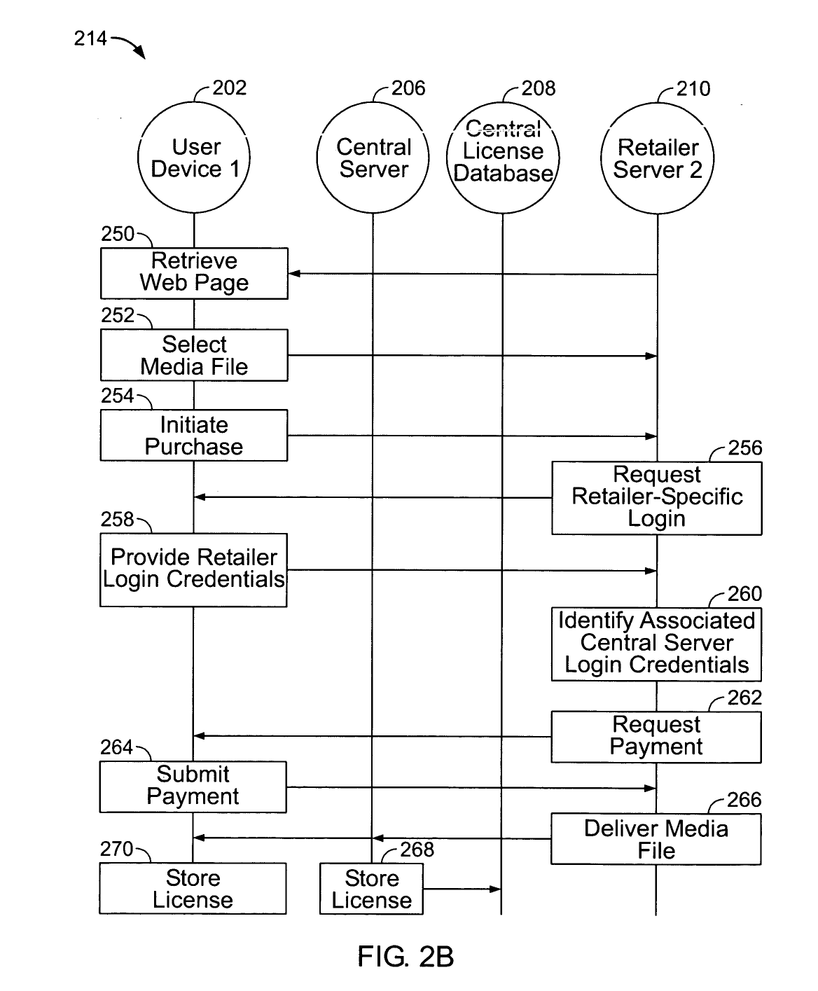

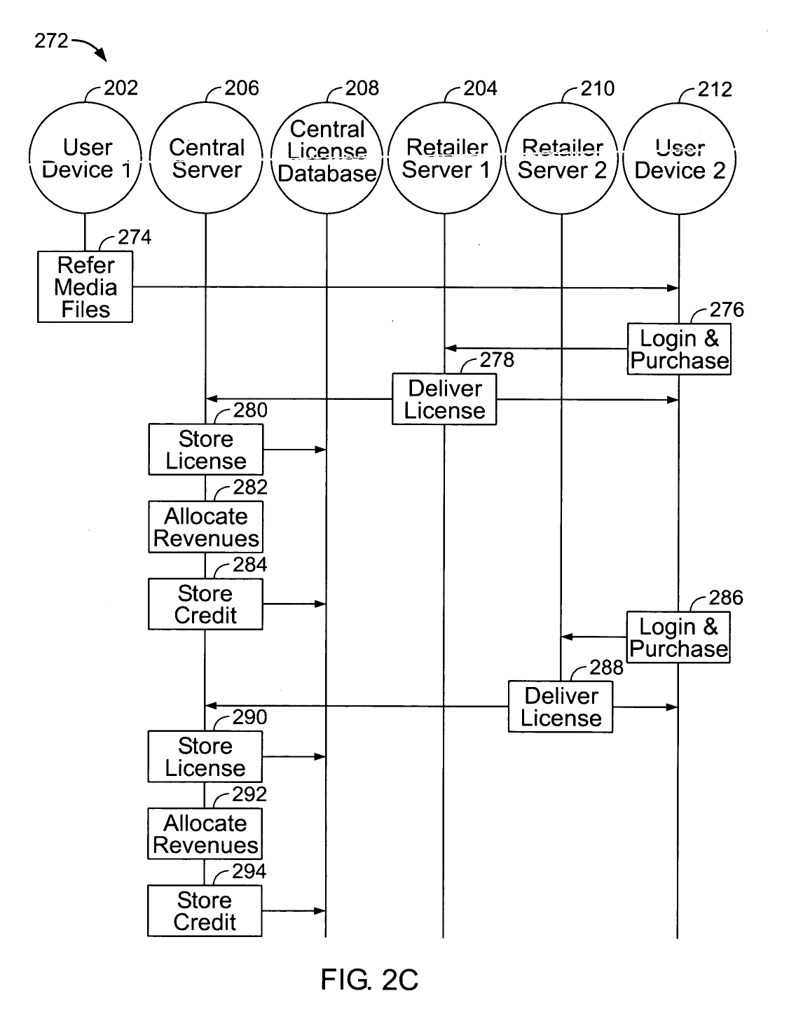

FIG. 2A is a signaling and flow diagram of a process 200 for purchasing and storing media file licenses. A user retrieves a web page from a first retailer server 204 using a first user device 202 (step 220). The web page may provide a listing of media files that can be purchased from the first retailer server 204 or may provide a search capability for searching for media files that can be purchased. Using the listing or as a result of conducting a search, the user identifies and selects one or more media files that the user wants to purchase (step 222). For example, the user can add media files to an online shopping cart. The user can then initiate a purchase of the selected media files (step 224). To complete the purchase, the user is requested to login with the first retailer server 204 (step 226). Assuming that the user has not previously registered with the first retailer server 204, the user registers with the first retailer server 204 to establish first retailer server login credentials (step 228).

The first retailer server 204 further requests that the user login with the central server 206 (step 230). In this example, it is assumed that the user has not previously registered with the central server 206. Accordingly, the user establishes central server login credentials (step 232), which can be performed through the first retailer server 204 or by redirecting the user to the central server 206 to obtain user registration information (step 234). Subsequently, logins with the central server 206 can be accomplished by simply obtaining the user's central server authentication credentials at the first retailer server 204 or by redirecting the user to a web page associated with the central server 206. The first retailer authentication credentials are associated with the central server authentication credentials (step 236). This association can be performed at the first retailer server 204 or at the central server 206. For example, the first retailer server 204 can store the user's central server authentication credentials in a local user profile associated with the user's first retailer server authentication credentials. Alternatively, the central server 206 can store the user's first retailer server authentication credentials in association with the user's central server authentication credentials. Thereafter, purchases made through the first retailer server 204 can be attributed to the user's identity at the central server 206 by sending at least part (e.g., a user name) of the user's first retailer server authentication credentials to the central server 206 along with data identifying the media files purchased.

The first retailer server 204 requests payment information, such as a credit card (step 238). In response, the user submits payment (step 240), and the purchased media file licenses are delivered to the central server 206 and the first user device 202 (step 242), where license data for the user is stored in a central license database 208 (step 244) and in a local database of the first user device 202 (step 246).

FIG. 2B is a signaling and flow diagram of a process 214 for purchasing and storing media file licenses from a different retailer server. As in steps 220 and 222, a web page for a second retailer server 210 is retrieved (step 250), and the user selects one or more media files for purchase (step 252). The user initiates a purchase of the selected media files (step 254). To complete the purchase, the user is requested to login with the second retailer server 210 (step 256). In this case, it is assumed that the user has previously registered with the second retailer server 210, so the user provides second retailer server authentication credentials (step 258). It is also assumed that the user has previously associated the second retailer server authentication credentials with the user's identity at the central server 206. Accordingly, the user's central server authentication credentials are identified (step 260). The second retailer server 210 requests payment information (step 262). In response, the user submits payment (step 264), and the purchased media file licenses are delivered to the central server 206 and the first user device 202 (step 266), where corresponding license data for the user is stored in a central license database 208 (step 268) and in a local database of the first user device 202 (step 270). As a result, licensing data corresponding to media file licenses purchased from two different retailer servers 204 and 206, each having their own independent authentication process, is stored in association with the same user identity at the central server 206.

FIG. 2C is a signaling and flow diagram of a process 272 for earning and storing referral credits. A user on a first user device 202 sends a referral for one or more media files to a user on a second user device 212 (step 274). For purposes of this example, the referred media files are assumed to be referred by the user of the first device 202 from two different retailer servers 204 and 210. The referrals can be made as part of a single message or other communication or as part of different communications. The user on the second user device 212 performs a login and purchase of some of the referred media file licenses from the first retailer server 204 (step 276), and corresponding license data is delivered to the central server 206 and the second user device 212 (step 278). The license data is stored in the central server license database 208 in an account associated with the purchasing user (step 280). The central server 206 also allocates revenues from the purchase (step 282), including identifying the referral by the user of the first device 202 and allocating credit to the referring user's account. The allocated credit is stored in the central license database 208 in association with the referring user's account (step 284).

The user on the second user device 212 also performs a login and purchase of additional referred media file licenses from the second retailer server 210 (step 286), and corresponding license data is delivered to the central server 206 and the second user device 212 (step 288). The license data is stored in the central server license database 208 in an account associated with the purchasing user (step 290). The central server 206 also allocates revenues from the purchase (step 292), including identifying the referral by the user of the first device 202 and allocating credit to the referring user's account. The allocated credit is stored in the central license database 208 in association with the referring user's account (step 294). Thus, the referring user can accumulate credits in a single account based on referrals to different retailer servers 204 and 210. In addition, the credits can generally be used for subsequent purchases from either the first or second retailer servers 204 or 210 or from some other retailer server that communicates with the central server 206.

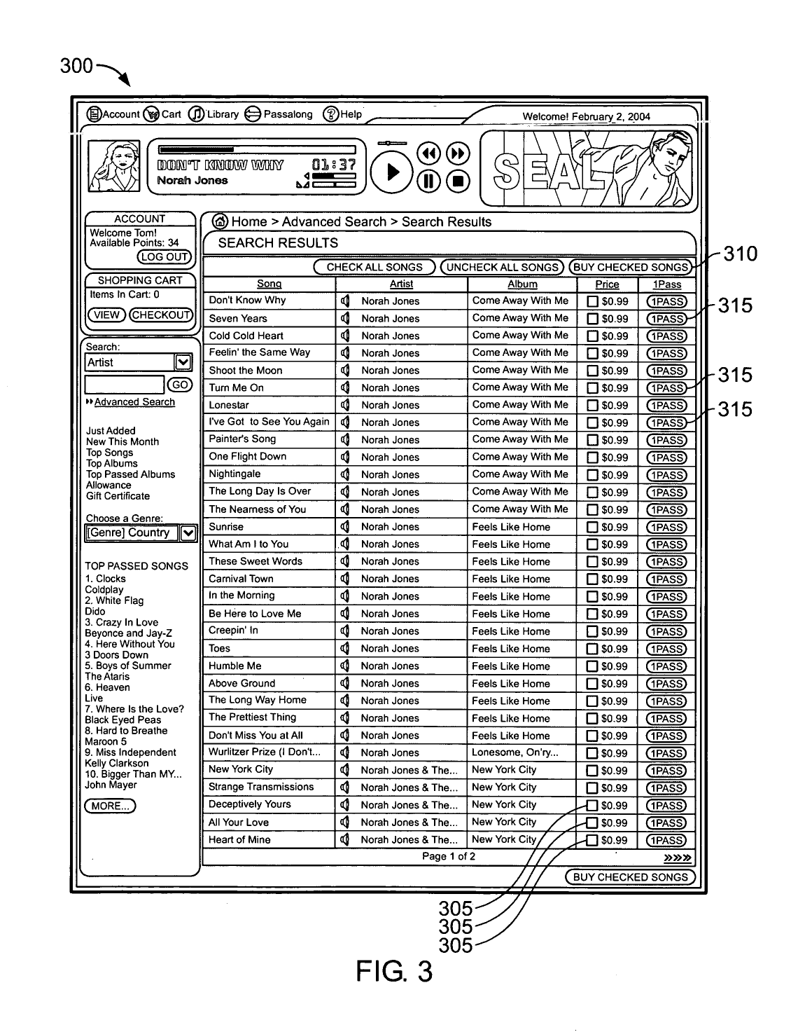

FIG. 3 is an example of a user interface 300 that can be used to purchase media file licenses. The user interface 300 includes a list of music files that meet certain search criteria. The user interface 300 includes a user interface component 305 for selecting music files, a user interface component 310 for initiating a purchase of the selected music files, and a user interface component 315 for referring selected music files to one or more other users. For example, by selecting the user interface component 315 for referring selected music files, another user interface can be displayed that allows the user to identify users (e.g., email addresses) to whom each music file is to be referred.

The central server described above can be used as part of a system designed to prevent unauthorized access to digital media files. For example, the central server can be used in connection with software on user devices to authorize access to and use of media files for which the user has a valid license.

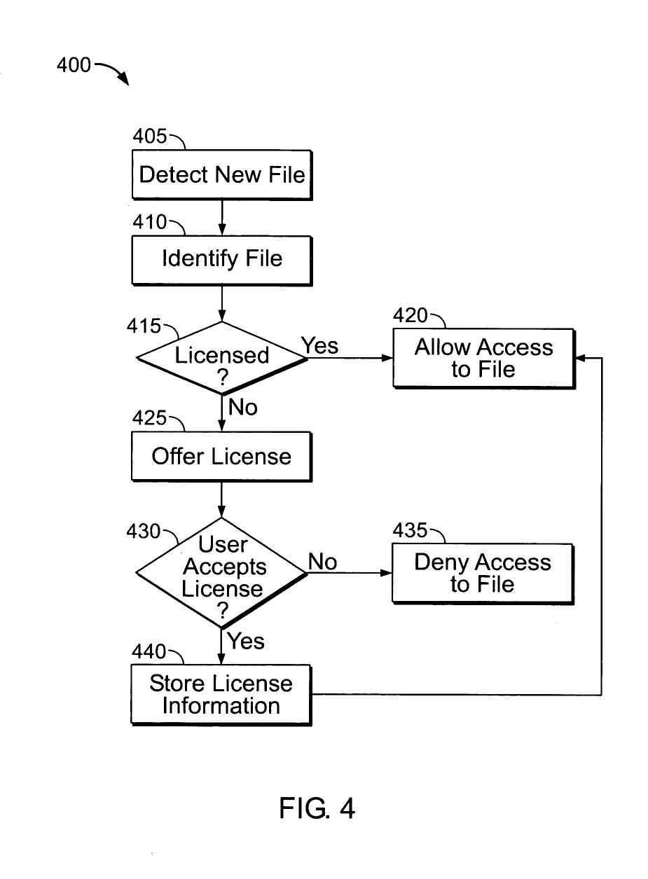

FIG. 4 is a flow diagram of a process 400 for managing digital rights to a file that is loaded onto a user device, such as a computer. The user device includes software interfaces with the I/O ports for the device to monitor all file I/O, much like a firewall, which scans all inbound and outbound traffic for the computer and checks all files being moved into and out of the system. Files may be loaded onto the device using any type of I/O port, including a floppy drive, an Ethernet or LAN connection, a dial-up connection, a CD-ROM or DVD drive, a USB port, an infrared data port, a Bluetooth or other wireless connection, or any other mechanism and/or protocol for transferring data to and from the user device.

When the file is loaded onto the user device, the file is detected (step 405). The detected file is further examined using file identification software in an attempt to identify the file (step 410). For example, the file identification software may determine if the received file represents a known song or movie (e.g., in MP3, Windows media, or some other format). This file identification may be performed by software implementing the techniques described in Roberts, et al., U.S. Patent Application Publication No. 20030028796, filed Jul. 31, 2002, Roberts, U.S. Patent Application Publication No. 20030046283, filed Oct. 29, 2002, and/or Wells, et al., U.S. Patent Application Publication No. 20030086341, filed Jul. 22, 2002, all of which are assigned to Gracenote, Inc. and all of which are incorporated herein by reference. This technology extracts a digital fingerprint from a digital file and compares the extracted fingerprint to a database of known works. More specifically, this technology can use algorithms to detect a media file type and a likelihood that the media file is of interest (e.g., represents a potentially protected work). Generally, these algorithms examine internal attributes of the file, instead of simply identifying the file type based on the file extension. Media files that are determined not to be of interest may be allowed to pass without further analyzing the file.

If the media file is found to be likely to be of interest, additional algorithms are used to identify the specific media file (e.g., the specific song, movie, photo, written work, etc.). Fingerprinting data that allows the specific media file to be identified may be stored at a central server and accessed using an Internet connection. Some files may be of a relevant file type but may not be recognized (e.g., if the media file represents a recording generated by the user or if access to a central database of digital fingerprints is not available). Access to such a file may be allowed without restriction, but the file may be flagged as unrecognized (e.g., by storing an indication on the user device that the unrecognized file has been accessed), which allows faster processing in the future and allows the Solution Software to potentially identify the media file at the time of a later use if the media file is subsequently catalogued or otherwise identified (e.g., when an internet connection to the central digital fingerprint database becomes available). If the file is subsequently identified or catalogued and is subject to restrictions, a stored indication that the unrecognized file was accessed may be used to require purchase of a license to continue using the file or to otherwise collect license fees for use of the file. In some implementations, data for a limited number of media files (e.g., the 2000 most popular song files) may be stored locally on the computer for quick access. The locally stored fingerprinting data may be periodically updated from the central server (e.g., as the popularity of song files changes).

The file identification techniques described above allow for accurate identification of the file even if someone has attempted to disguise the file (e.g., by changing the file name, extensions, or other attributes) and regardless of whether the file is received in compressed or uncompressed form (e.g., using standard practices for reading compressed information). Such techniques offer a very low error rate of less than 2% (less than 1% false negatives and less than 1% false positives).

Other file identification techniques may also be used, such as watermarking and fingerprinting techniques, as are known in the field of digital rights management. In some cases, it may not be necessary to identify the file using complex file identification techniques. Instead, the file may be identified based on a file name or using file ID attributes, which may be contained in or with the file and may be designed to be tamper-resistant. For example, if the media file is wrapped, the file identification software may operate to detect the wrapper and read file ID information embedded in the wrapper. Thus, files can be identified using implicit characteristics of the file (e.g., a fingerprint or watermark) or using explicit file characteristics (e.g., a file identifier stored in a file header).

Once the file has been identified, a determination is made as to whether the file has been licensed for use on the user device and/or by the particular user (step 415). This determination may be performed by referring to one or more license databases, which may be stored locally (e.g., on the user device) and/or remotely (e.g., at a central server). To ensure that the license information in the license database is valid, one or more special keys may be used to access the information, unlock the license database, and/or to validate the user, the user device, and/or the license on the user device itself or by communicating with a central server, as discussed in greater detail below. If the file is licensed, the user may be allowed to access the file (step 420), which may involve, for example, unwrapping the file, playing a song or movie contained in the file, storing or otherwise using the file on the user device, or streaming the file to the user device over a wireless or wired connection. The license may specify what type of access or use of the file is permitted.

If the file is not licensed, a license may be offered to the user for purchase (step 425). For example, the user may be directed to a website where a purchase can be made, or a pop-up window may appear on a display screen for the user device asking whether the user wishes to purchase a license to the file or otherwise accept certain license terms and/or the user may be directed to a website where a purchase can be completed. Alternatively, the user may have a service that allows for pre-purchasing of a certain number of credits that may be applied to license purchases. As another alternative, the number of unlicensed media used in a particular period may be monitored locally by the Solution Software or other software, and this information may be subsequently used to calculate usage fees or rates. The license terms, such as duration, use and distribution limitations, and payment options, may also be displayed as part of the offer of a license for purchase. It is then determined whether the user accepts the license (step 430) (e.g., by receiving an indication that the user clicked on an accept button or a decline button in the pop-up window). If the user does not accept the license, access to the file may be denied (step 435). If the user does accept the license, including complying with any payment terms, the user is allowed to access the file, and license information, indicating that the file has been licensed and any other necessary information, is stored in the license database(s) (step 440).

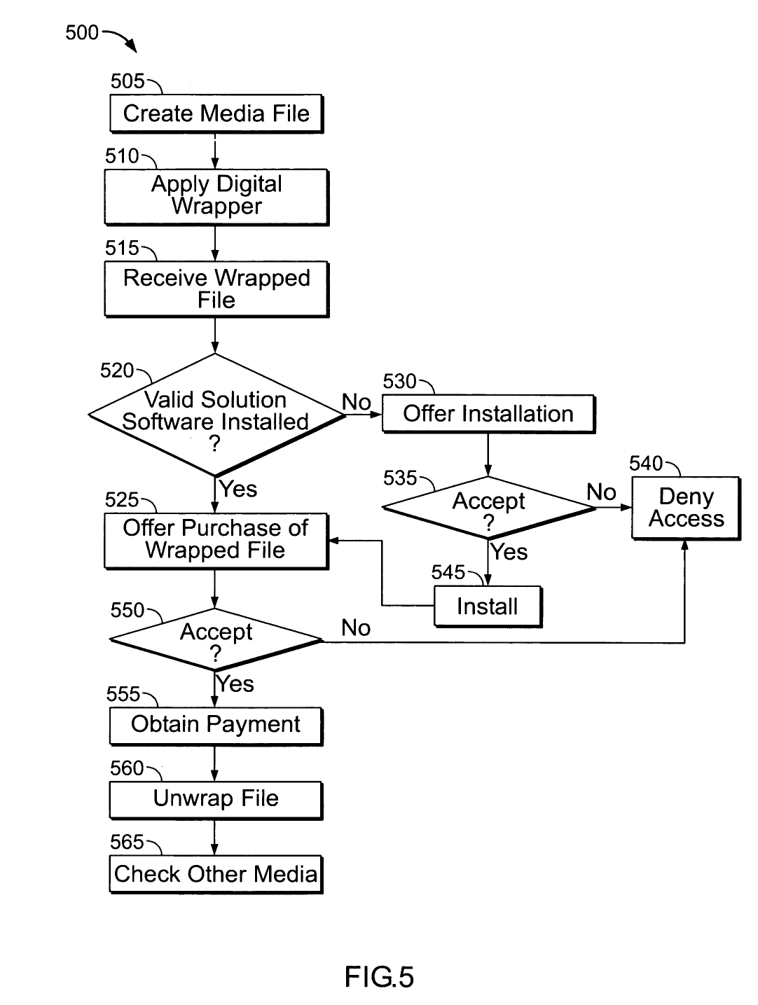

FIG. 5 is a flow diagram of a process 500 for installing, on a user device, software (“Solution Software”) that controls access to protected files. The Solution Software may perform a number of different functions, including gathering information for generating keys, communicating with the central server, monitoring the file I/O system, storing and retrieving license information from the local database, identifying files (e.g., using the Gracenote or other technology), wrapping and unwrapping files, and facilitating the purchase of licenses. The Solution Software may be installed on a user device in a number of different ways. Traditional download and software install processes are one way for the Solution Software to be installed. The installation process can be initiated when the user device receives wrapped files. Other potential installation processes could involve seeding current peer-to-peer networks with songs wrapped by the Solution Software, sending the Solution Software, or a link to a server that stores the Solution Software, using instant messaging or emailing, and other alternatives. The process 500 illustrated in FIG. 5 illustrates an installation initiated as a result of receiving a wrapped file.

Initially, a data file is created (step 505). If the data file is a song, for example, the creation of the data file may include an artist recording a song and the artist, label, and publisher working together to create a song that is ready for distribution. Alternatively, an independent artist may self produce and publish a song for distribution. The song may subsequently be “ripped,” which involves taking a song from a digital source such as a CD or DVD or an analog source and encoding the song into an MP3 file, Windows Media file, Real Player file, or other media format for playback on a computer or music/media player device.

A digital wrapper may then be applied to the media file (step 510). The content owner (e.g., the record label, publisher, or independent artist) or someone else in the distribution chain may apply, adjust, or enhance the digital wrapper to the media file. The digital wrapper may include attributes such as a title, author/artist, and volume/collection along with business rules specifying ownership, usage rights, royalty fees, and pass-along payout levels (i.e., commissions that will be paid to individuals along the distribution chain). This combined information is given a “Unique File ID” (UFID) and may be stored in a central database (see FIG. 2). The UFID is included in the wrapper during any and all transmissions and is used as a mechanism to identify the media file and to trigger specific functions like copyright owner payment events, file usage database updates, and micro-payment fee allocations for consumer pass-along activities. The Solution Software may include processes for verifying the integrity of a file and its UFID to prevent UFID and wrapper tampering. For example, the file recognition techniques discussed above with respect to files that do not include a unique embedded ID may be used to “recognize” the file by generating a derived ID. The derived ID may then be checked against a corresponding stored ID to ensure that the file and its unique embedded identifier have not been subject to tampering.

In addition to information about the media file, the wrapper prevents unauthorized access to the media file. In other words, the wrapper prevents access to the media file unless the user has purchased a license. In essence, the wrapper places the file in an encrypted form that requires a key to be able to access the underlying media file. Conventional digital wrappers that are typically used for protecting software applications as they are distributed electronically may be used as a wrapper for the media file. For example, the wrapper may be of the same type as the ecommerce wrapper available from Digital River, which has been used to distribute software such as Norton Antivirus from Symantec Corporation and Aladdin Software's Privilege system. Once the user purchases a license for himself or for the device, a key is used to unwrap the media file. The key may be received from the central server.

Typically, all communications between the user device and the central server occur with two levels of encryption. First, transmissions are encrypted via SSL/TLS (Secure Sockets Layer/Transport Layer Security also known as Secure HTTP). Second, transmitted keys are secured via public and private key pairs and a symmetric key. A certificate specific to the user's device may be issued to the user device at installation to ensure the computer can be trusted for communication by the central server. The certificate indicates that the sender is who it says it is. The central server can then send its public key to the sending computer. The sending computer encrypts the information it wishes to transmit with a symmetric key and then encrypts the symmetric key with the public key of the central server. The central server uses its private key to decode the symmetric key and then uses the symmetric key to decode the received information. Examples of symmetric key algorithms include DES (digital encryption system), 3DES (Triple-DES), and simple cipher transcription algorithms. A popular example of a key pair encryption algorithm is PGP (Pretty Good Privacy). The methodology described can be used in reverse to send information from the central server to the user's device.

In general, each media file may have a corresponding unique key, or a particular key may be shared among two or more media files. To improve security, the specific encryption method used may be unique to each file. Thus, multiple encryption techniques may be used, and the wrapper may include an encryption technique identifier to inform the Solution Software of which decryption technique to use for unwrapping the file. The wrapper may also include an executable component that runs whenever a user tries to open the wrapped file. Among other things, the executable component determines whether a valid installation of the Solution Software exists on the user device.

Note that the license database local to the device can be encrypted. This encryption typically uses a symmetric key algorithm as described above. To improve security, layers of security can be added (also described above) and the encryption scheme may be changed from time to time in communication with the central server. The described techniques utilize combinations of data and encryption seed values to generate the symmetric keys. Elements of these encryption seeds include information specific to the local user and/or device, including information that is bound to the device's hardware and non-volatile memory. This enhances the system's ability to make the encryption specific to the local machine. In this way, encryption and identification keys generated for a system cannot be used on another system.

Wrapped files are typically encrypted using symmetric keys as described above. The encrypted contents are stored within the executable wrapper. Accordingly, keys may be used for a variety of different security functions, including protecting (i.e., locking) and unlocking a wrapped file, locking and unlocking a local database, protecting communications between the user device and the central server and/or central database, authenticating the user, authenticating the user device to the central server, and authenticating the central server to the user device.

A user device may subsequently receive the wrapped file (step 515) through a physical or electronic media distribution technique. For example, a user may receive the wrapped file on his computer from a peer-to-peer platforms such as Morpheus, KaZaA, Napster, Grokster, etc.; in an email received from another person; through a file access and download process (FTP or HTTP) from a web site, telephone or satellite network, whether or not the site is a legitimate distributor of the digital content; in a person-to-person file sent via instant messaging or other direct connect methods; or via other media, such as network connection, CD-ROM or CDR, DVD-R, Zip disk, and the like.

When a user attempts to open or otherwise access the wrapped media file (e.g., by double clicking on the file), the executable component of the digital wrapper determines whether a valid installation of the Solution Software already exists on the user device (step 520). During installation of the Solution Software, the central server creates a unique key, which may include a “Unique Customer ID” (UCID) associated with the user and/or a device key. The unique key is generated by combining, according to a predetermined algorithm, a number of data types, which may include device specific information, data gathered from user input, data generated by the Solution Software or central server, and local database access and location information. The data, or at least some parts of the data, is generally sent to the central server from the user device, and the central server uses the received data to generate the unique key. The central server then encrypts this information and sends the information back to the user device where the information is stored in a secure, non-volatile area on the user device, such as the BIOS. Among other things, the unique key allows the central server to recognize the consumer, enabling the user to use licensed data files and receive payment for “promoting” (pass-along) files to other consumers. The presence of the unique key on the user device, along with the executable Solution Software and supporting files, thus indicates that a valid installation of the Solution Software exists on the user device. If the unique key is present but the user has been removed all or part of the software and supporting files, on the other hand, a reinstallation of the Solution Software is necessary.

Accordingly, when a user attempts to access the wrapped media file, the Solution Software checks the BIOS for a valid unique key by conducting a memory read of the BIOS data tables, which may be written to the SMBIOS (also known as DMI) standard (as defined in the “System Management BIOS Reference Specification version 2.3 (Section 2.1—Table Specification)”, where the unique key is written when the Solution Software is installed. If the unique key is not found, the executable component of the wrapper determines that the Solution Software is not yet installed. If a unique key is found in the BIOS, the unique key is read and verified with the central database to ensure the found unique key is valid. The central database decrypts the unique key and calculates and verifies a checksum. As an alternative to using a checksum, other verification methods, such as the inclusion of an additional key or handshake token in the exchange between the client device and the central server, may be used. In some situations or implementations, verification of the unique key's validity may be performed by the Solution Software on the user device. If the unique key and checksum do not match, the executable component of the wrapper determines that valid Solution Software is not currently installed. If the unique key and checksum do match, it is determined that a valid installation exists. In some implementations, such as where the local system has limited processing resources (e.g., in a cell phone), the process of checking for a valid installation may be performed at the central server.

In addition, if the unique key indicates that a valid installation exists, the Solution Software located on the user device may be validated against unique identification information for the Solution Software that is included in unique key stored in the BIOS. For example, the unique key stored in the BIOS may include a checksum and version for the Solution Software, which may or may not be stored in an encrypted form, that are compared to a checksum and version for the Solution Software located on the user device. If this information does not match, the executable component of the wrapper determines that valid Solution Software is not currently installed. Otherwise, a valid installation is recognized.

Although not illustrated in FIG. 5, there may be situations in which the wrapped file is already licensed (i.e., a license to access the file is already stored in a local or central license database) or the file, without the wrapper, already exists on the user device (e.g., the file was ripped onto the user device from a CD before the Solution Software was installed on the user device). In the latter case, it may be presumed that the user is entitled to a license to access the file. To determine if the file already exists on the user device, it is generally necessary to scan the storage devices connected to the user device to discover what files exist on the user device. The handling of files that are already licensed on the user device or that are already present on the user device are further discussed below.

If the executable component of the wrapper determines that valid Solution Software is not currently installed, an offer to install the Solution Software is presented on the user device (step 530). The offer may be presented, for example, in a pop-up window. It is then determined whether the user accepts the offer to install the Solution Software (step 535) (e.g., by receiving an indication that the user clicked on an accept button or a decline button in the pop-up window). If the user does not accept the offer, the Solution Software is not installed and access to the wrapped media file is denied (step 540). If the user accepts the offer, the Solution Software is installed (step 545) from a central server that stores the Solution Software code or from code included in the wrapper.

Once the solution software is installed at step 545 or if the executable component of the wrapper determined at step 520 that a valid installation of the Solution Software already exists (and assuming the wrapped media file is not already licensed by the user and/or on the user device), an offer to purchase or license the wrapped media file is presented on the user device (step 525). Alternatively, the user may be directed to a website where a purchase or license of the file can be completed. It is then determined whether the user accepts the purchase or license offer (step 550). If not, access to the wrapped media file is denied (step 540).

In some implementations, installation of the Solution Software may not occur until after presenting the offer to purchase or license the wrapped media file at step 525 or even after the user accepts the purchase or license offer at step 550. Accordingly, an offer to purchase or license (step 525) the wrapped media file may be presented on the user device regardless of whether a valid installation of the Solution Software is found on the user device at step 520 and before a copy of the Solution Software is installed at step 545. In such a case, the Solution Software may be installed, without requiring a separate offer and acceptance for the Solution Software, at about the same time as, or after, determining whether the user accepts the purchase or license offer at step 550. Accordingly, step 545 may be performed roughly concurrently with step 550 or after step 550, and steps 530 and 535 may be omitted. As another alternative, steps 530 and 535 may be performed at some other point during the process 500.

If the user accepts the purchase or license offer, payment information is obtained from the user and sent to the central server (step 555). The central server may include a micro-payment system that tracks the sale of the media file license and also all the parties to be paid for each specific sale, as further discussed below. If this purchase is the first time the user has purchased a media file, the billing information including payment method and related information as well as address and phone contact information are entered. Otherwise, the user may have the option to log in and use a previous payment method or to enter a new payment method.

The payment method is processed. If the payment fails, the user can enter a different payment method and try again. If the user chooses not to try again or if no payment method offered is validated, the transaction is cancelled and access to the media file is denied. Assuming payment is successful, however, the media file is unwrapped (step 560) and license information may be stored, as appropriate, in a local database and/or a central database.

Once the Solution Software is installed on the user device, the Solution Software may check all media on the user device (step 565) to determine whether any of the media files represent protected content. This check may be performed by scanning the contents of the user device's memory and using a file identification technique to identify known media files. Recognized media files may then be wrapped to enable the user to promote and sell his/her own cataloged library, as further discussed below. In specific implementations, the media files may be wrapped upon recognition or may not be wrapped until a user attempts to send the file through the I/O system of the user device. In addition, the user may be required to purchase a license for any recognized content for which the user does not already possess a license. In some implementations, however, it may be undesirable to require purchase of a license for files that already reside on the user device when the Solution Software is installed because it may not be possible to determine if the user legitimately possesses the file (e.g., if the user previously paid for the file before the Solution Software was installed on the user device). Files that already exist on the user device, however, may be wrapped upon transfer to another device and/or another user.

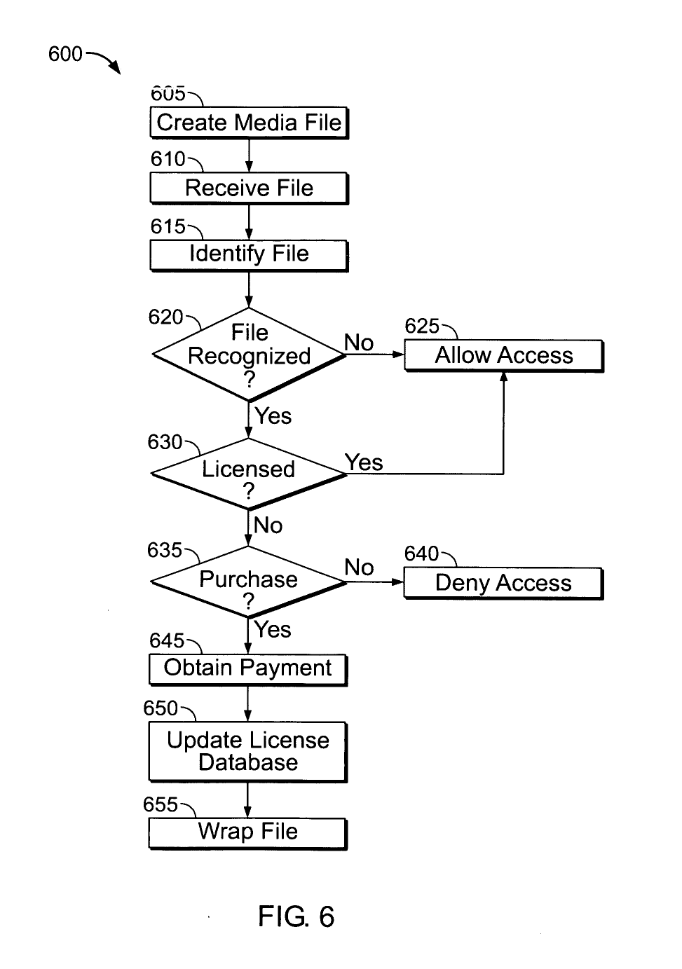

FIG. 6 is a flow diagram of a process 600 for wrapping content that arrives without any digital wrapper on a user device that includes the Solution Software. Initially, a media file is created (step 605), as described above in connection with FIG. 5. The media file is subsequently received on a user device that includes the Solution Software (step 610) through a physical or electronic media distribution technique. The Solution Software monitors the file I/O system and thus recognizes the receipt of the media file. Using a file identification technique, the Solution Software attempts to identify the media file (step 615) by, for example, extracting a digital fingerprint from the media file and comparing the fingerprint with fingerprints of known media files. A determination is made as to whether the media file is recognized (step 620). If not, it may be assumed that the file is not protected by copyright or otherwise, and access to the media file may be allowed (step 625).

If the file is recognized, it is determined whether the media file has already been licensed for use on the user device and/or by the particular user (step 630). In general, when a file is recognized, the file identification techniques will identify an existing UFID associated with the media file. To determine if the media file is licensed for use on the user device, the Solution Software may determine if the UFID is stored in a local database that contains UFIDs for licensed media files. In some cases, the user may have a license to the media file but the license information may not be stored on the user device. For example, the user may have purchased a license using a different device. Assuming the business rules for the media file do not limit use of the media file to a particular device (i.e., the device on which the media file was originally licensed) or otherwise preclude use of the media file on the current user device, access to the media file may be permitted. Accordingly, if the UFID is not found in the local database, a central database may be checked to determine if the user has a license for the media file.

If it is determined that the media file is licensed, access to the media file may be allowed (step 625). In some cases, it may be determined that a valid license exists, and access to the media file may be allowed, even if the file is not contained in a license database for the user. For example, if the file is being loaded onto the user device from a compact disc (CD), the Solution Software may be able to recognize whether the CD is factory-produced and, if so, may be programmed to assume that the attempt to copy the file is legitimate or permissible. Accordingly, the Solution Software may allow copying of files from an original CD and may store license information for files that are copied from an original CD (see step 640 of FIG. 6). However, the Solution Software may also be programmed to prevent further copying of a file that is received from a CD. In particular, the Solution Software may wrap a file that is copied from a CD, either at the time that the file is recognized or upon detecting that the file is being transferred through the I/O system for the user device.

If the media file is not licensed, the user may be offered the opportunity to purchase a license to use the media file (step 635). If the user opts not to purchase a license, access to the media file may be denied (step 640). If the user decides to purchase a license, payment information is obtained from the user and sent to the central server (step 645). Assuming payment is successful, license information for the media file may be stored, as appropriate, in a local database and/or a central database (step 650). The media file may also be wrapped for further distribution (step 655), which ensures that the media file is licensed and that the appropriate fee distributions are made before others can access the media file. As discussed above, the media file may be wrapped immediately. Alternatively, the media file may remain in an unwrapped form on the user device and be wrapped only when a user attempts to send the media file through the I/O system for the user device.

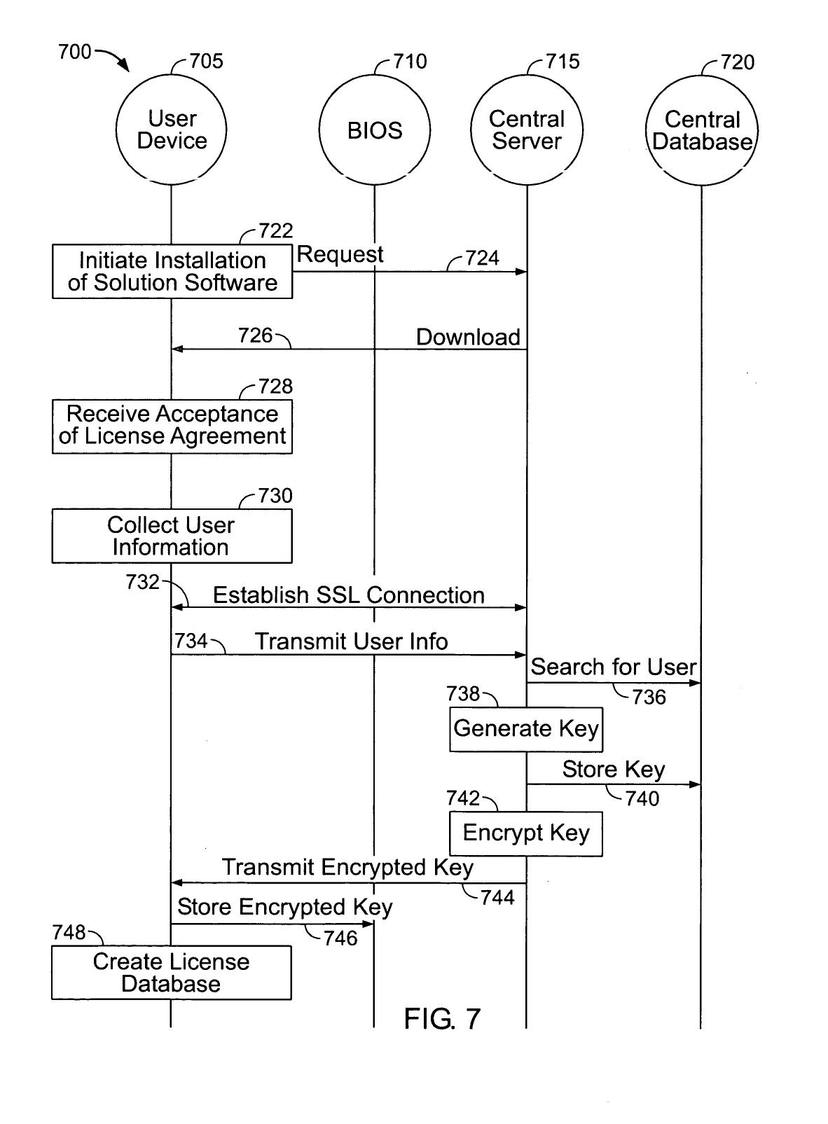

FIG. 7 is a signaling and flow diagram of a process 700 for generating a UCID for a user and/or a key that is specific to the user device. In general, each user will have a single UCID and each user device will have its own specific device key. The UCID may be used for identifying the user for purposes of accessing the user's license information stored at the central server, tracking the source of files for purposes of identifying payments (i.e., when a user has added his/her UCID to a file wrapper and distributed the file to other purchasers), and for identifying certain user devices as belonging to a particular user. The specific device key may be used for unlocking and/or accessing the local license database as well as allowing the central server to identify the specific device. The UCID and the specific user device key may also be merged into a combined key by simply appending one to the other or by intermixing the keys according to some type of coding algorithm. A combination of the UCID and the specific user device key may be used for distinguishing among the specific user devices that belong to a particular user (e.g., so the central server can keep track of which devices on which a licensed file resides).

The process 700 involves operations on and communications between a user device 705, a BIOS 710 for the user device 705, a central server 715, and a central database 720. An installation of the Solution Software on the user device 705 is initiated (step 722). As a result, the user device 705 sends a request 724 to the central server 715 for the Solution Software. In response to the request 724, the Solution Software is downloaded 726 from the central server 715 to the user device 705. Instead of sending a request 724 and performing a download 726, the Solution Software may be loaded locally (e.g., from a file located on the user device 705 or from a disk). The user may be prompted to accept the terms and conditions of a license agreement for the Solution Software, and acceptance of the license agreement may be received (step 728).

The Solution Software that is loaded onto the user device 705 includes executable code necessary to collect certain user-related information (step 730). Some of the information may be collected automatically while other information may require manual input by the user. For example, the user may be prompted to enter a unique user name or “handle,” a password, an email address, and other user input information. This information may be used to access the user's license and other information stored in the central database and/or to access a local database specific to the user on a user device 705 that may be shared by multiple users. Information that is automatically gathered may include device specific information (e.g., System Universal User ID, CPU ID, MAC address, BIOS boot block) and access and location information for the local database.

The Solution Software that is loaded onto the user device 705 also includes executable code necessary to establish a connection 732 between the user device 705 and the central server 715. Typically, an Internet connection between the user device 705 and the central server 715 is made automatically. If automatic connection is not possible, a manual process is started to prompt the user to initiate a connection (using a modem, network, etc.). If no Internet connection is made, the installation aborts, in which case the information gathered at step 730 may be stored for a subsequent attempt to install the UCID and specific device key when an Internet connection is available. Installation of the Solution Software may similarly be aborted at steps 722, 724, & 726 in cases where the Solution Software is installed from the central server 715. The Internet connection is made via a secure channel such as Secure Sockets Layer (SSL).

Information sent to the central server 715 may be sent on this secure channel, and the information may have additional encryption applied to it (e.g., using PGP in addition to the encryption provided by the SSL connection). Messages sent to the central server 715 may be responded to with a success or fail code. Messages sent which receive no response in a programmatically determined reasonable timeframe may be assumed to have failed. Using the established connection, the user information collected at step 730 is transmitted 734 to the central server 715.

The central server 715 may search 736 the central database 720 to see if the user is already known. Determining if the user is already known may involve a comparison of one or more of the data items of user information to known data items stored in the central database 720. For example, if the user name is already in the central database 720 but the password does not match, the user may be prompted to log in with the correct password and/or notified that the user name is already in use.

If the user is not already known, the central server 715 generates a UCID and/or a device key (step 738). The UCID and the device key may be generated by combining a selected number of data items, which may be selected from among a various available data items including the received device specific information, the received user information gathered from user input, the received access and location information for the local database, data generated by the central server 715, and information regarding the date and time of, or other information about, the transaction. As discussed above, the UCID may be combined with the specific device key to create a combined key. Which data items are used and how the data items are combined may be defined by algorithms stored in the central server 715. By generating the UCID, device key, and/or combined key at the central server 715, the algorithms for generating the UCID, device key, and combined key may be kept secure, which may help prevent users from being able to generate counterfeit UCIDs, device keys, and combined keys. In addition, reverse engineering of the UCID, device key, and combined key and/or the algorithm for producing the UCID, device key, and combined key may be further prevented by using less than all of the user information received from the user device 705 and/or randomly selecting some of the data items to be used in generating the UCID and by encrypting the UCID before sending the UCID to the user device 705.

The UCID, device key, combined key, and/or additional machine specific information, along with the other user information, is stored 740 in the central database 720). The UCID, device key, and/or combined key are also encrypted (step 742), and the encrypted UCID, device key, and/or combined key are transmitted 744 to the user device 705, which stores 746 the encrypted UCID, device key, and/or combined key in the BIOS 710. The keys may be split into parts and the different parts of the keys may be stored at separate locations in the BIOS. The UCID, device key, and/or combined key may represent a public key that subsequently may be used to encrypt messages between a client machine and the central server. A local license database is created on the user device 705 (step 748). For example, a portion of the Solution Software code is run to create an encrypted license database on the user device 705. By encrypting the database and/or the information stored in the database, it is possible to prevent the information contained in the database from being readable unless the appropriate keys are used. Generally, the license database is created on a hard drive of the user device 705 with a location pointer stored in the BIOS 710, but the license database may also be created in the BIOS 710. The encrypted UCID and the device key and/or combined key, which may include one or more location pointers, are written to the BIOS using an industry standard process, such as Desktop Management Interface (DMI), for storing extended data structures.

Consumers often have multiple devices and want to be able to use licensed files on the various devices. In some situations, therefore, the process 700 may be initiated on a new device but by a user who already has a UCID. Based on the UCID, a user name and password, and/or other identifying information, the central server 715 may determine that the user is already known during the search 736. The user may still be able to install the Solution Software on other devices and login with his/her user name and password. The central server 715 may generate a new device key without having to generate a new UCID (at step 738) and update the combined key with the new device information. Thus, the combined key may include the UCID along with device specific information (e.g., specific device keys) for all devices owned or used by the user.

When the combined key is received by the central database, the combined key may be unencrypted by the central server to identify the user (using the UCID portion of the combined key) and to determine whether the user device is a new device or a known device for the user (using the device specific information contained in the combined key). If the device is a new device, the new device may be added to the list of known devices for the registered user, and the device can then use data files based on license permissions for the individual files (e.g., the number of different devices on which a media file may be used without purchasing an additional license). The UCID and/or the updated combined key (as well as a new device key) may also be added to the BIOS of the new device so that the device may be associated with the specific user. The UCID and/or the updated combined key may also be added to the BIOS of the user's other devices the next time those devices connect to the central server. A specific device may also be associated with multiple users, in which case each user may have a separate license database and the separate license databases may be distinguished using a user name and password. Additionally, a device without the Solution Software but that is authorized to communicate with a license library in the local database or the central database 720 could be permitted to use licensed files based on the license information located in the license library.

In some situations, users may be permitted to access licensed files on a temporary basis using, for example, borrowed devices. For instance, a user may want to listen to a music file while at a friend's house. In such a case, the device may be temporarily added as an additional device (e.g., with an expiration date/time), the file may be granted a temporary license on the device, or the file may be provided to the device in a streaming format. To prevent users from allowing others to access their licenses, however, users may be limited to one concurrent login at a time and/or such temporary licenses may be granted for a limited time or to only one device at a time.

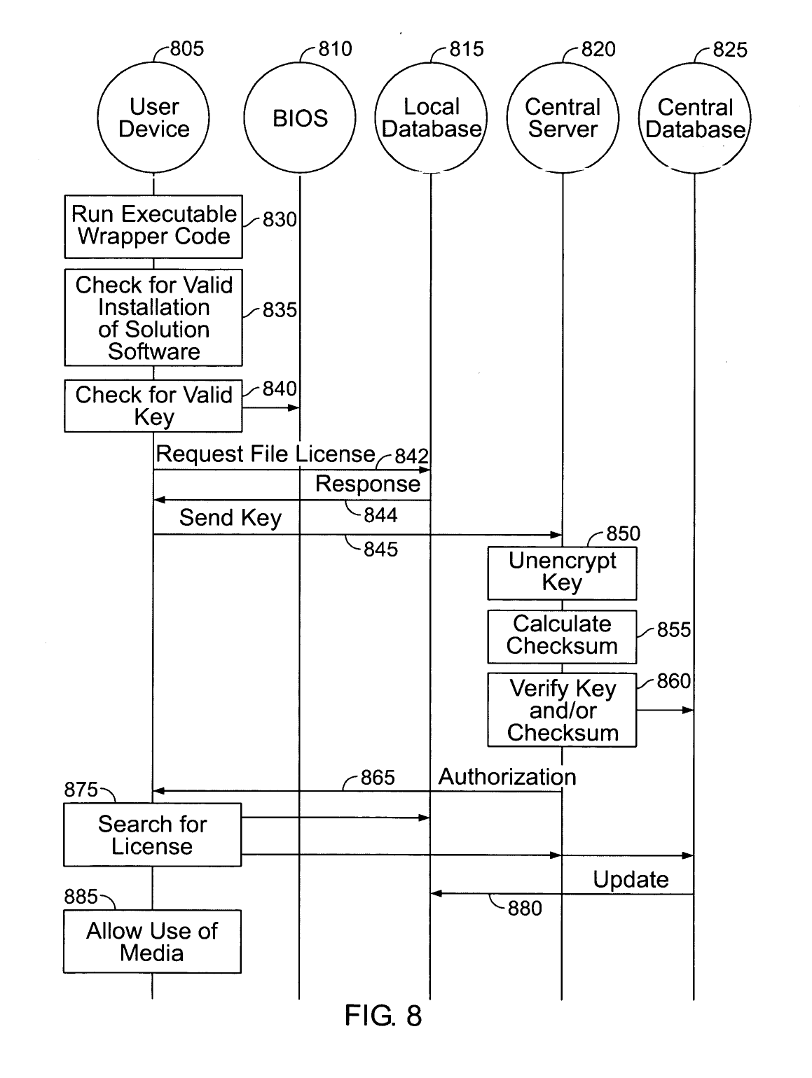

FIG. 8 is a signaling and flow diagram of a process 800 for accessing a media file in a case where a user already has a license for the media file. The process 800 involves operations on and communications between a user device 805, a BIOS 810 for the user device 805, a local database 815, a central server 820, and a central database 825. The user device 805 receives a wrapped file as in step 715 of FIG. 7. When the user attempts to open the wrapped file, executable wrapper code is run on the user device 805 (step 830). The executable code may cause the user device 805 to first check for a valid installation of the Solution Software (step 835). Assuming a valid installation is found, the executable code may cause the user device 805 to check for a valid UCID, device key, and/or combined key in the BIOS 810 (step 840), which may involve a memory read of the DMI tables where the key is written when the Solution Software is installed.

If a valid UCID, device key, and/or combined key are found, the Solution Software on the user device 805 may check for a license to the wrapped file in the local database 815 by sending a file license request 842. This search may be conducted by identifying the media file's UFID, which is contained in the digital wrapper, and trying to locate the UFID in the local database 815. The local database 815 may be unlocked by comparing unique machine information from one or more keys stored in the BIOS with the actual unique machine information. If the information matches, the Solution Software can then decrypt the local database to read license information. If the information does not match, the keys may be designed such that an attempt to decrypt the local database will be unsuccessful (e.g., to thwart unauthorized copying of the license database to a different device), in which case it may be necessary to contact the central server 820 to obtain authorization or to register the user device 805 (see FIG. 7). Decrypting the local database 825 and/or the license information contained in the local database 825 may be performed using a digital key stored in the BIOS to unlock the local database 825 or its content.

Assuming the local database 825 is successfully decrypted, a response 844 containing the necessary license information or an indication that the file is not currently licensed on the user device 805 is returned to the user device 805. If the license information is returned, access to the file may be allowed (step 885). Otherwise, it may be necessary to access the central database 825 to determine if the user device 805 is an authorized device and/or to determine if a valid license exists. Each time the central server 820 and/or central database are accessed, it may be necessary to test the keys stored on the user device against information stored in the central database 825 to ensure that the communication involves a valid, authorized user device 805. The following steps describe testing of a combined key. Although a combined key may be used, other implementations may use a UCID, a device key, and/or other information. If a combined key is found in the BIOS 810, the found key is sent 845 to the central server 820 for verification along with additional machine specific information (i.e., the information or some of the information originally used to generate the combined key). The central server 820 decrypts the received combined key to retrieve the UCID (step 850) and embedded device information. The central server may additionally calculate a checksum for the unencrypted combined key (step 855). The central server then verifies the unencrypted combined key against information stored in the central database (step 860). Verifying the combined key may include calculations with the checksum. If the unencrypted combined key, UCID, and machine information match the information stored in the central database, an authorization 865 to proceed is sent to the user device 805 indicating a successful verification of the combined key. If the combined key is counterfeit or copied from another device, the machine specific information sent along with the combined key will not match the information contained in the unencrypted key and the information stored in the central server.

In response to the authorization 865, which may be used once per session when connecting to the central database 825, the executable code causes the user device 805 to search the local database 815 for a license to the media file (step 875) by trying to locate the UFID for the media file in the local database 815. In some cases, this search may be successful even though the original search (at 842) was not if, for example, the key information stored locally became corrupted but is updated through the authorization 865. If the UFID is not found in the local database 815, the central database 825 maybe searched for the UFID. If the UFID is found in the central database 825, the local database is updated 880 with the license information. Assuming a license is located, use of the media file is allowed (step 885). For example, the Solution Software may allow a media player application to access a requested music file. In some implementations, once a media file is allowed to be used on a particular user device 805, the media file is stored on the user device 805 in an unwrapped form. The wrapper is only reapplied by the Solution Software when the software detects that the media file is being copied or moved from the user device 805 to another device or storage medium, which may be determined through monitoring of the file I/O system as discussed above. In other implementations, the media file may be stored on the user device 805 in a wrapped form and may be unwrapped using license information stored in the local database 815 each time the media file is opened.

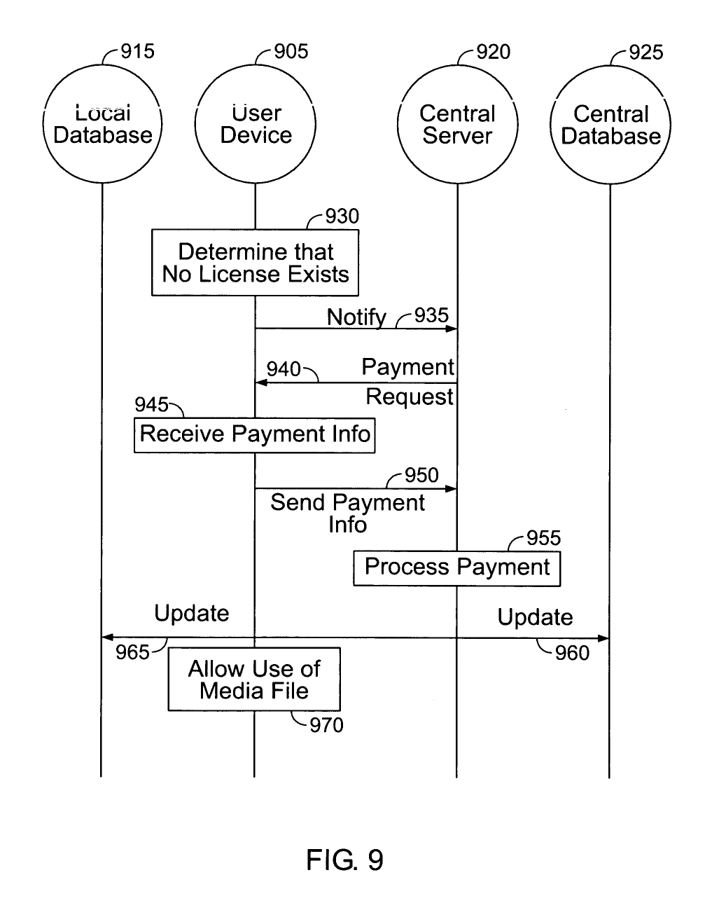

FIG. 9 is a signaling and flow diagram of a process 900 for accessing a media file in a case where a user does not have a license for the media file. The process 900 involves operations on and communications between a user device 905, a local database 915, a central server 920, and a central database 925. The process 900 begins with a determination that the user does not have a license for the media file (step 930). This determination may be the result of a failed search for a license in step 875 of FIG. 8. In response to this determination, the user device 905 notifies 935 the central server 920 that a license is needed. The central server 920 responds with a payment request 940, which is displayed on the user device 905 or the user is directed to a website where payment information can be obtained. The user device 905 receives payment information from the user (step 945) and sends the payment information to the central server 920. The payment information is processed (step 955), which may involve determining how much of the license fee is allocated to the content owner and/or to one or more users who have distributed the media file. The central database 925 is updated 960 with information indicating that the user has a license to the media file. The central database 925 may also be updated with payment allocation information. In addition, the local database 915 is updated 965 with information indicating that the user has a license to the media file. Based on the updated license information, the user may be allowed to use the media file on the user device 905 (step 970).

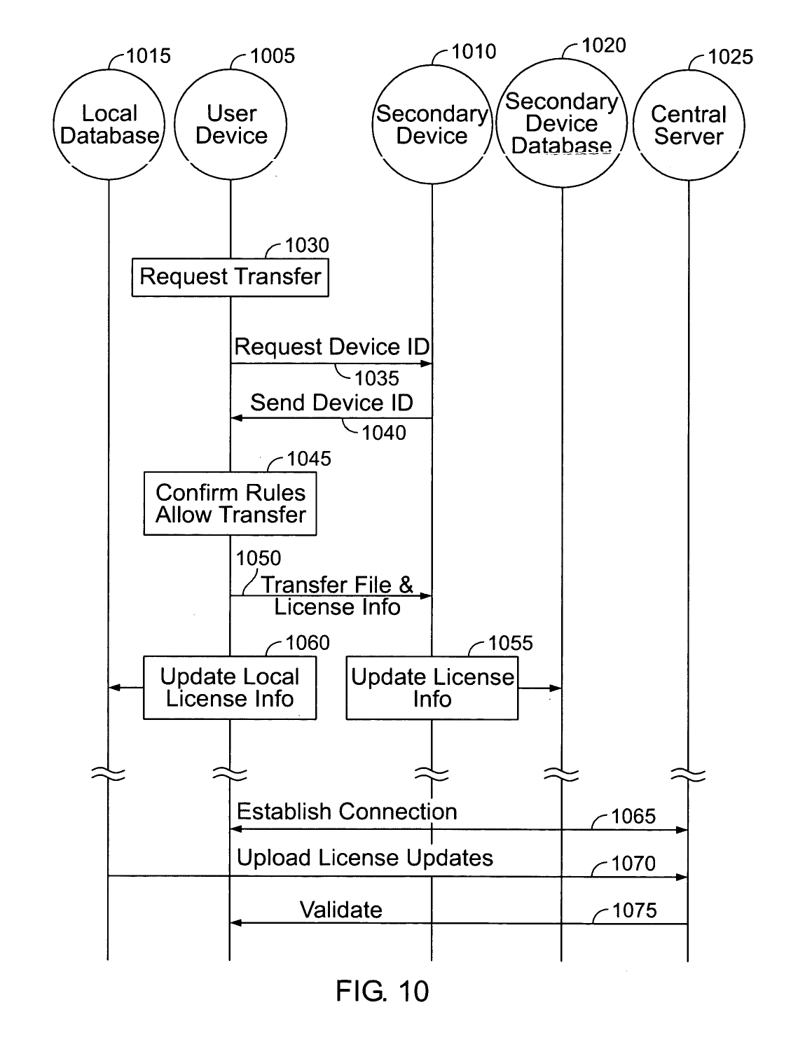

Some devices may not be capable of communicating directly with the central server if, for example, the devices cannot conveniently connect to the Internet. Media files may be transferred to such devices in a manner that prevents the media files from being further transferred to other devices without the wrapper. In these situations portions of the computer code may be installed in firmware and a small local license database may be installed in the device's writable memory. FIG. 10 is a signaling and flow diagram of a process 1000 for copying or moving a media file from a user device 1005 to a secondary device 1010. The process 1000 involves operations on and communications between the user device 1005, the secondary device 1010, a local database 1015, a secondary device database 1020, and a central server 1025. The secondary device 1010 may be, for example, a satellite connected car audio system, cellular phone, MP3 player, or other portable device and may connect to the user device using a cable such as but not limited to an IEE 1394 firewire or USB cable, or could be connected via a wireless connection. A version of the Solution Software may be pre-installed (e.g., at the factory) on the secondary device 1010.

A request to transfer a media file is received by the user device 1005 (step 1030). In response, the user device 1005 requests 1035 a device ID from the secondary device 1010. The secondary device responds 1040 with its device ID. The user device 1005 confirms that the business rules contained in the wrapper for the media file allow the requested transfer (step 1045). For example, the business rules may place a limit on the number of devices to which the media file can be copied. Assuming that the transfer is permitted, the wrapped media file and the corresponding license information may be transferred 1050 to the secondary device 1010. The secondary device 1010 may store the license information in the secondary device database 1020 (step 1055). The license information, in conjunction with the pre-installed Solution Software, may allow the secondary device 1010 to access the wrapped media file. In addition, the user device 1005 may update the local license information in the local database 1015 (step 1060). This update may store information indicating that a copy of the media file has been transferred to the secondary device 1010.

Subsequently, a connection may be established 1065 between the user device 1005 and the central server 1025. This connection may be established in response to an attempt to access a new media file, an attempt to locate license information, or a requirement that the user device 1005 periodically validates the licenses stored in the local database 1015 to continue using the licenses. Using the connection, the license updates stored in the local database 1015 may be uploaded 1070 to the central server 1025 (and stored in the central database), which allows the central server to keep track of the devices on which copies of the media file are located and to prevent the media file from being copied onto more devices than are allowed under the business rules. The central server 1025 may also validate 1075 the existing licenses stored in the local database 1015.

Techniques may also be provided for supporting the distribution of media files from user to user and allowing users to benefit from revenues generated as a result of their distribution of media files to others. A user may electronically send other consumers information about media files he owns or enjoys. If a sale is made as a result of the pass-along, the user may earn a percentage of the revenue generated from the sale of the media file and even subsequent sales of the media file. The media file wrapper can contain information identifying the original reseller and distributor in the event that the user received the media file from a recognized reseller and distributor, as well as information identifying the user who further distributes the media file. Based on business rules associated with the file, this information enables the reseller and the user to receive compensation for purchases made as the media file is passed along. Additionally, where a file is sent or received unwrapped, a referring user, reseller, and distributor can still be compensated as long as their unique identification is included with the transaction data. For example, it may be possible for a purchaser to identify a referring user, in which case the central server may determine how the referring user received the file and reconstruct the distribution chain, including identifying who should share in the revenue.

Business rules can determine if a user that has not licensed the media file can still profit from redistribution of the media file. For example, a user may house files on a server, acting as a redistribution point, and may be paid a pass-along participation fee, even though the user does not own a license for the files he/she is distributing.

When someone begins the process of sending a file to a friend, the Solution Software creates a newly wrapped version of the media file, preparing the media file for the pass-along process. This new wrapper includes the UFID for the media file, the business rules that apply to the media file, and the UCID for the originating user (or users), which allows the user (or users) to be compensated when he/she promotes a song that is purchased by the receiving user. Reseller and Distributor ID information can also be included in the wrapper. The Solution Software performs this same process when a user device is used to rip a CD or DVD. For example, when songs on a CD are ripped onto a computer, licenses for the songs are installed in the license database. Subsequently, if the songs are transferred through the I/O system for the computer, a wrapper may be applied to the songs. The wrapper may include licensing and payment information, which may be retrieved from the central database based on song identification information contained in the ripped file or based on identification information obtained using the file identification techniques discussed above. If the songs are burned onto a CD, wrapped files may be written to the CD. Alternatively, the Solution Software could create a dual session CD, which contains the media information files, such as the UFID and the UCID with reseller and distributor information, in the PC readable area of the CD. In a dual session CD format, traditional audio files could be permitted in the audio section of the CD, allowing the CD to be played on conventional CD players. If the files are loaded in a device on which the Solution Software is installed, however, the files would require licensing.

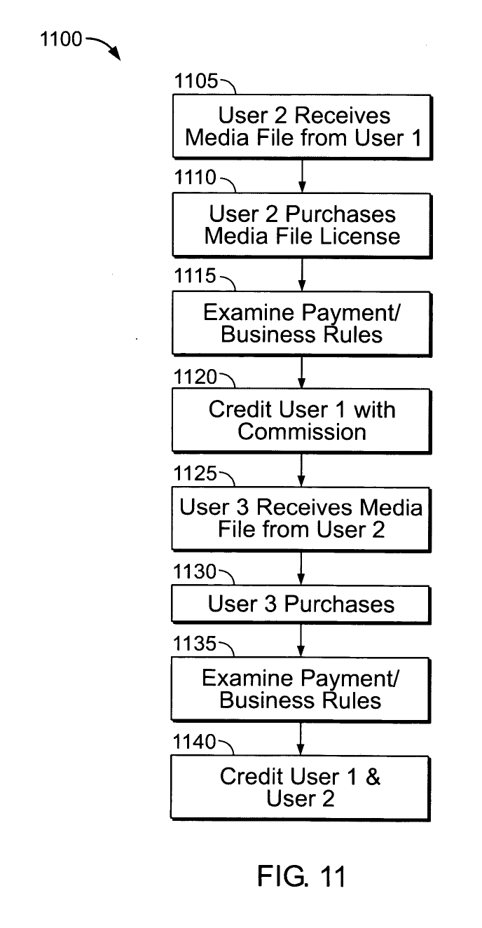

FIG. 11 shows a flow diagram of an illustrative process 1100 for performing a pass-along distribution. Initially, User2 receives a media file from User1 (step 1105). User2 purchases a license for the media file received from User1 (step 1110). In connection with the payment processing, the business rules associated with the media file are examined (step 1115). This examination may be performed on a user device, at a central server, or at another location. User1 is then credited with a commission in an amount specified by the business rules (step 1120). The commission may be credited to a micro-payment account managed by a central server, may be credited to User1 for use in future purchases of media file licenses, or may be deposited to User1 's bank account through a micro-payment system.

Subsequently, User3 receives a media file from User2 (step 1125). User3 purchases a license for the media file received from User2 (step 1130). In connection with the payment processing, the business rules associated with the media file are again examined (step 1135). User1 and User2 are then credited with a commission in an amount specified by the business rules (step 1140). Accordingly, multiple levels of payments may be made for the distribution of the media file.

In some implementations, the central server credits and tracks all accounts from user pass-along activity, much like a savings account. All account holders can track and use their funds either in payment for additional music or as a withdrawal to be transferred as monetary finds via electronic funds transfer (EFT) or another suitable method. This applies to all parties that participate in the revenue stream including users, resellers, distributors, and content managers, such as record companies, publishers, and artists. The number of levels of payment and the amount of the payment to each level is established in the creation of the UFID by the holder of the ownership for the file (usually the copyright holder or publisher) and can vary depending on business rules.

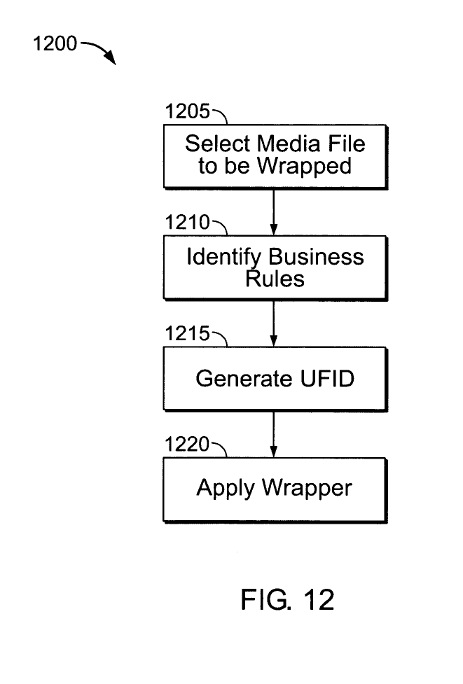

FIG. 12 is a flow diagram of a process 1200 for wrapping a media file. The process begins with a selection of a media file to be wrapped (step 1205). Business rules to be associated with the media file are identified (step 1210). The business rules may be established by the owner or publisher of the media file. The business rules may include payment information and information relating to limitations on use and copying of the media file. A UFID is generated for the media file (step 1215). The UFID may incorporate the business rules and/or may serve as a pointer to business rules that are stored in the central database. Generally, the UFID is associated with a particular work (e.g., a specific recording by a specific artist) regardless of whether a specific copy of the work is wrapped or unwrapped. Accordingly, when file identification techniques are used to identify a media file, a recognized media file will have a particular UFID that corresponds to the media file. A wrapper that incorporates the UFID is then applied to the media file (step 1220). The wrapper generally includes an encryption of the media file, such that a user can only remove the wrapper with a license to the media file. Although the Solution Software may generally preclude moving files without the wrapper, there may be situations in which a file may be moved without the wrapper, such as if a user burns a standard audio CD and the content of the CD is subsequently ripped into another computer. In the event that the file is moved without the wrapper, recognition techniques can be used to identify the file and look up the associated UFID and its business rules in the central database.

The described techniques can be implemented in digital electronic circuitry, integrated circuitry, or in computer hardware, firmware, software, or in combinations thereof. Apparatus for carrying out the techniques can be implemented in a software product (e.g., a computer program product) tangibly embodied in a machine-readable storage device for execution by a programmable processor; and processing operations can be performed by a programmable processor executing a program of instructions to perform the described functions by operating on input data and generating output. The techniques can be implemented advantageously in one or more software programs that are executable on a programmable system including at least one programmable processor coupled to receive data and instructions from, and to transmit data and instructions to, a data storage system, at least one input device, and at least one output device. Each software program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory, a random access memory and/or a machine-readable signal (e.g., a digital signal received through a network connection). Generally, a computer will include one or more mass storage devices for storing data files; such devices include magnetic disks, such as internal hard disks and removable disks, magneto-optical disks, and optical disks. Storage devices suitable for tangibly embodying software program instructions and data include all forms of non-volatile memory, including by way of example semiconductor memory devices, such as EPROM (electrically programmable read-only memory), EEPROM (electrically erasable programmable read-only memory), and flash memory devices; magnetic disks such as internal hard disks and removable disks; magneto-optical disks; and CD-ROM disks. Any of the foregoing can be supplemented by, or incorporated in, ASICs (application-specific integrated circuits).

In some implementations, the user device on which a file is displayed, played, or otherwise delivered to the user may not have a local storage medium or memory that is capable of or sufficient to store the Solution Software and/or the local license database. In such a case, the file may be streamed to, or otherwise temporarily stored on, the user device. Accordingly, the processor or processors on which the Solution Software is run, and thus that control access to the file, may be located remotely. Such remote processors may serve as proxies for user devices that cannot store information locally.

To provide for interaction with a user, the techniques can be implemented on a computer system having a display device such as a monitor or LCD (liquid crystal display) screen for displaying information to the user and a keyboard and a pointing device such as a mouse or a trackball by which the user can provide input to the computer system or a system which enables input and presents information via voice, symbols, or other means such as a Braille input and output system. The computer system can be programmed to provide a graphical user interface through which computer programs interact with users. With new technologies such as voice input and output, it is not a requirement to have a visual display to implement the described techniques.

A number of implementations have been described. Nevertheless, it will be understood that various modifications may be made. For example, the steps in the processes illustrated in FIGS. 2A-C, 4-12 may be rearranged and/or certain steps may be omitted. Accordingly, other implementations are within the scope of the following claims.

What is claimed is:

1. A method for managing license rights in digital media, the method comprising:
storing digital media license records associated with a plurality of user identities, with the license records for each user identity accessible from a remote device using a first authentication credential corresponding to the user identity;
offering digital media licenses for purchase using second authentication credentials;
associating a particular second authentication credential with the first authentication credential corresponding to a particular user identity; and
storing, in association with the particular user identity, a record for a digital media license purchased using the particular second authentication credential based on the association of the particular second authentication credential with the first authentication credential corresponding to the particular user identity.

2. The method of claim 1 wherein each of the first authentication credential and the second authentication credential for each user identity comprises a user name and a challenge response.

3. The method of claim 1 wherein the digital media license records includes at least one of parameters for a license or a digital media file identifier.

4. The method of claim 1 further comprising storing a plurality of device identifiers associated with the particular user identity, wherein licenses for digital media identified by the license records for the particular user identity allow use of the digital media on devices having one of the plurality of device identifiers.

5. The method of claim 1 wherein the license records include data identifying digital media discovered on a device associated with a user identity.

6. The method of claim 1 wherein the first authentication credential is associated with a central server and the second authentication credential is associated with a retailer server.

7. The method of claim 6 wherein the central server stores rules defining an allocation of revenue among multiple entities for purchases of digital media.

8. The method of claim 1 further comprising allocating credit to an account associated with a first user identity in response to a purchase of a digital media license using a second user identity, wherein the purchase is made in response to a referral from the first user identity to the second user identity.

9. A method for managing license rights in digital media, the method comprising:
storing digital media license records associated with a plurality of user identities;
receiving data identifying a first purchase of a first digital media license from a first retailer entity, with the data including information sufficient to identify a particular user identity associated with the first purchase;
storing, in the digital media license records, a record of the first purchase in association with the particular user identity;
receiving data identifying a second purchase of a second digital media license from a second retailer entity, with the data including information sufficient to identify the particular user identity as being associated with the second purchase; and
storing, in the digital media license records, a record of the second purchase in association with the particular user identity.

10. The method of claim 9 wherein each of the first purchase and the second purchase is made using the particular user identity.

11. The method of claim 10 wherein the record of the first purchase comprises an association of a digital media license for the first digital media with the particular user identity and the record of the second purchase comprises an association of a digital media license for the second digital media with the particular user identity.

12. The method of claim 9 wherein each of the first purchase and the second purchase are made in response to a referral made using the particular user identity.

13. The method of claim 12 wherein the record of the first purchase and the record of the second purchase comprise credits to an account associated with the particular user identity.

14. The method of claim 13 wherein the credits are usable for making purchases of a digital media license through at least one of the first retailer entity or the second retailer entity.

15. The method of claim 9 further comprising providing access to the records to each of the first retailer entity and the second retailer entity.

16. The method of claim 9 further comprising allocating revenue from purchases among the first retailer entity, an owner of the digital media, and an entity associated with the central server.

17. The method of claim 9 wherein each of the first retailer entity and the second retailer entity have independent catalogs of digital media for purchase.

18. A system for managing license rights in digital media, the system comprising:
at least one retailer server operable to offer digital media licenses for purchase using a retailer-specific authentication credential associated with a particular user identity;
a central server operable to store digital media license records associated with a plurality of user identities, with the license records for the particular user identity accessible from a remote device using a primary authentication credential associated with the particular user identity, wherein the license records for the particular user identity are automatically updated to include a record of a digital media license purchased using the retailer-specific authentication credential associated with the particular user identity.

19. The system of claim 18 wherein the central server is further operable to store rules defining a distribution of revenue among at least an operator of each retailer server and an operator of the central server.

20. The system of claim 18 wherein each of the at least one retailer server is further operable to retrieve information from the digital media license records associated with the particular user identity.

21. The system of claim 18 wherein the central server is further operable to store data identifying credits earned by the particular user identity for purchases made using other user identities, with the purchases associated with a referral made using the particular user identity.

22. The system of claim 18 wherein each of the at least one retailer server is further operable to support a transmission of a licensed digital media file using the particular user identity.

23. A system for managing license rights in digital media, the system comprising:
a plurality of retailer servers, with each retailer server operable to offer digital media licenses for purchase and each retailer server having an independent digital media catalog;
a central server operable to store digital media license records associated with a plurality of user identities, with the license records for a particular user identity including a record of a digital media license purchased through a first retailer server of the plurality of retailer servers and a digital media license purchased through a second retailer server of the plurality of retailer servers.

24. The system of claim 23 wherein the central server is further operable to support a security mechanism for restricting use of a digital media file without a digital media license.

25. The system of claim 23 wherein the central server is further operable to provide access to the digital media license records by the plurality of retailer servers.

26. The system of claim 23 wherein the central server is further operable to store rules for allocating revenue at least among an operator of the central server and an operator of a retailer server through which a purchase that produces the revenue is made.

27. The system of claim 26 wherein the central server is further operable to store data defining revenues allocated to each of the operator of the central server and the operators of the plurality of retailer servers.
